(19) United States
(12) Patent Application Publication
(10) Pub. No.: US 2026/0119937 A1
(43) Pub. Date: Apr. 30, 2026

(54) PASSIVE DYNAMICAL DECOUPLING OF MAGNETIC FIELD SENSITIVE SUBLEVELS

(71) Applicant: Quantinuum LLC, Broomfield, CO (US)

(72) Inventor: Robert Tyler SUTHERLAND, San Antonio, TX (US)

(21) Appl. No.: 18/907,144

(22) Filed: Oct. 4, 2024

Related U.S. Application Data
(60) Provisional application No. 63/600,861, filed on Nov. 20, 2023.

(51) Int. Cl. G06N 10/40; H01F 7/20

(52) U.S. Cl. CPC G06N 10/40; H01F 7/20

(57) ABSTRACT

A confinement apparatus confines quantum objects and includes a magnetic field control circuit (MFCC) associated with a defined location of the confinement apparatus. Passive dynamical decoupling of magnetic field sensitive sublevels is performed on a quantum object disposed at the defined location by controlling current provided to the MFCC to cause the MFCC to generate an applied magnetic field at the defined location that is aligned with a static quantization field associated with the confinement apparatus and that has an amplitude that is larger than an amplitude of the static quantization field; and controlling the current provided to the MFCC to cause the applied magnetic field to rotate such that an experienced quantization field experienced by the quantum object at the defined location rotates. An angular velocity of the rotation of the experienced quantization field is <2π times a frequency difference between adjacent hyperfine sublevels of the quantum object.

### CROSS-REFERENCE TO RELATED APPLICATIONS

This application claims priority to U.S. Application No. 63/600,861, filed Nov. 20, 2023, the content of which is incorporated herein by reference in its entirety.

### TECHNICAL FIELD

Various embodiments relate to passive dynamical decoupling of magnetic field sensitive sublevels. Various embodiments relate to the use of magnetic field control circuits to control an experienced quantization field experienced by a quantum object in order to perform passive dynamical decoupling of magnetic field sensitive sublevels of the quantum object.

### BACKGROUND

Various atomic systems and quantum systems include object having magnetic field sensitive sublevels. For example, neutral or ionic atoms may have hyperfine sublevels where the energy and/or frequency of a respective sublevel is dependent on the magnetic field being experienced by atoms. These atoms may be used in atomic clocks, as qubits or qudits of a quantum charge-coupled device (QCCD)-based computer, and/or other systems. When using the hyperfine sublevels of the atoms for performing experiments, controlled quantum state evolution, and/or the like, the dependency of the energy and/or frequency of the sublevels on the experienced magnetic field causes magnetic field noise to interfere with and/or affect the results of the experiment, controlled quantum state evolution, and/or the like.

Through applied effort, ingenuity, and innovation many deficiencies of such systems have been solved by developing solutions that are structured in accordance with the embodiments of the present invention, many examples of which are described in detail herein.

### BRIEF SUMMARY OF EXAMPLE EMBODIMENTS

Example embodiments relate to systems, apparatuses, methods, computer program products, and/or the like for performing passive dynamical decoupling sequence of magnetic field sensitive sublevels of a quantum object. In various embodiments, the quantum object is a qubit or a qudit of a quantum computer (e.g., a quantum charge-coupled device (QCCD)-based quantum computer). In various embodiments, a quantum object is confined at a defined location of a confinement apparatus. The confinement apparatus is associated with a static quantization field which is a magnetic field that is substantially uniform in direction and amplitude across the confinement apparatus and that is substantially constant and/or unchanging with time during performance of an experiment and/or controlled quantum state evolution using one or more quantum objects confined by the confinement apparatus.

The confinement apparatus includes one or more magnetic field control circuits (MFCCs) that are operable to generate a magnetic field at the defined location. In an example embodiment, the operation of the MFCCs is controlled to cause performance of passive dynamical decoupling of magnetic field sensitive sublevels of the quantum object disposed at the defined location. In various embodiments, performing a passive dynamical decoupling sequence includes generating an applied magnetic field using the MFCCs such that the quantum object disposed at the defined location experiences an experienced quantization field which is the combination of the applied magnetic field and the static quantization field. The operation of the MFCCs is then controlled to cause the experienced quantization field to rotate in an adiabatic manner.

According to a first aspect, a method for passively dynamically decoupling magnetic field sensitive sublevels of a quantum object confined by a confinement apparatus at a defined location is provided. The confinement apparatus (a) is configured to confine one or more quantum objects and (b) includes at least one magnetic field control circuit (MFCC) associated with the defined location. The defined location is defined at least in part by the confinement apparatus. In an example embodiment, the method includes controlling current provided to the at least one MFCC to cause the at least one MFCC to generate an applied magnetic field at the defined location that is in a direction that is aligned with a static quantization direction of a static quantization field associated with the confinement apparatus and that has an amplitude that is larger than an amplitude of the static quantization field. The static quantization direction defines a static quantization axis. The method further includes controlling the current provided to the at least one MFCC to cause the applied magnetic field generated by the at least one MFCC to rotate such that an experienced quantization field experienced by the quantum object disposed at the defined location rotates. An angular velocity of the rotation of the experienced quantization field is less than two pi times a frequency difference between adjacent hyperfine sublevels of the quantum object.

In an example embodiment, the method further includes, when the experienced quantization field is rotated substantially 180 degrees from the static quantization direction, controlling the current provided to the at least one MFCC to cause the amplitude of the applied magnetic field to decrease to less than the amplitude of the static quantization field while the experienced quantization field remains parallel to the static quantization axis.

In an example embodiment, the method further includes, when the experienced magnetic field is rotated an integer multiple of 360 degrees, controlling the circuit provide to the at least one MFCC to cause the amplitude of the applied magnetic field to decrease to less than the amplitude of the static quantization field while the quantization field remains aligned with the static quantization direction.

In an example embodiment, the rotation of the experienced quantization field is performed while the quantum object is in a magnetic field sensitive sublevel.

In an example embodiment, the method is performed by a controller configured to control one or more current and/or voltage sources configured to provide current and/or voltage signals to one or more electrical components of the confinement apparatus.

In an example embodiment, the controller is configured to control the current provided to the at least one MFCC by controlling operation of a respective current and/or voltage source of the one or more current and/or voltage sources.

In an example embodiment, the controller comprises a non-transitory memory device and the method further comprises storing quantization field rotation information corresponding to the rotation of the experienced quantization field in the non-transitory memory device in association with a quantum object identifier configured to identify the quantum object dispose at the defined location during the rotation of the experienced quantization field.

In an example embodiment, the quantum object is a qubit of a quantum computer comprising the confinement apparatus, and the rotation of the experienced quantization field is performed during performance of a quantum circuit by the quantum computer.

In an example embodiment, rotation of the experienced quantization field causes a modification in a hyperfine sublevel energy linear dependence on magnetic field such that magnetic field-based noise experienced by the quantum object is reduced by performance of the rotation of the experienced quantization field.

According to another aspect, a system configured for performing passive dynamical decoupling of magnetic field sensitive sublevels of a quantum object is provided. In an example embodiment, the system includes a confinement apparatus configured to confine the quantum object. The confinement apparatus (a) defines, at least in part, a defined location and (b) comprises at least one magnetic field control circuit (MFCC) associated with the defined location. The system further includes one or more current and/or voltage sources configured to provide electrical current and/or voltage signals to one or more electrical components of the confinement apparatus; and a controller configured to control operation of the one or more current and/or voltage sources. The controller includes at least one processing element and a non-transitory memory storing executable instructions. The memory and the executable instructions are configured to, when executed by the at least one processing element, configured to cause the controller to perform at least controlling a current provided to the at least one MFCC to cause the at least one MFCC to generate an applied magnetic field at the defined location that is in a direction that is aligned with a static quantization direction of a static quantization field associated with the confinement apparatus and that has an amplitude that is larger than an amplitude of the static quantization field. The static quantization direction defines a static quantization axis. The memory and the executable instructions are further configured to, when executed by the at least one processing element, configured to cause the controller to perform at least controlling the current provided to the at least one MFCC to cause the applied magnetic field generated by the at least one MFCC to rotate such that an experienced quantization field experienced by the quantum object disposed at the defined location rotates. An angular velocity of the rotation of the experienced quantization field is less than two pi times a frequency difference between adjacent hyperfine sublevels of the quantum object.

In an example embodiment, the memory and the executable instructions are further configured to, when executed by the at least one processing element configured to cause the controller to perform at least, when the experienced quantization field is rotated substantially 180 degrees from the static quantization direction, controlling the current provided to the at least one MFCC to cause the amplitude of the applied magnetic field to decrease to less than the amplitude of the static quantization field while the experienced quantization field remains parallel to the static quantization axis.

In an example embodiment, the memory and the executable instructions are further configured to, when executed by the at least one processing element configured to cause the controller to perform at least, when the experienced magnetic field is rotated an integer multiple of 360 degrees, controlling the circuit provide to the at least one MFCC to cause the amplitude of the applied magnetic field to decrease to less than the amplitude of the static quantization field while the quantization field remains aligned with the static quantization direction.

In an example embodiment, the rotation of the experienced quantization field is performed while the quantum object is in a magnetic field sensitive sublevel.

In an example embodiment, the controller is configured to the current provided to the at least one MFCC by controlling operation of the one or more current and/or voltage sources.

In an example embodiment, the memory and the executable instructions are further configured to, when executed by the at least one processing element configured to cause the controller to perform at least storing quantization field rotation information corresponding to the rotation of the experienced quantization field in the non-transitory memory in association with a quantum object identifier configured to identify the quantum object dispose at the defined location during the rotation of the experienced quantization field.

In an example embodiment, the quantum object is a qubit of a quantum computer comprising the confinement apparatus and the controller, and the rotation of the experienced quantization field is performed during performance of a quantum circuit by the quantum computer.

In an example embodiment, the confinement apparatus is a surface ion trap formed on a chip and the at least one MFCC is an integrated circuit formed on or in the chip.

In an example embodiment, the MFCC comprises a first circuit element that is parallel to a confinement axis of the confinement apparatus at the defined location and second and third circuit elements that are parallel to one another and transverse to the first circuit element.

In an example embodiment, the controller is configured to independently control respective currents applied to the first circuit element, second circuit element, and third circuit element.

In an example embodiment, the first circuit element, second circuit element, and third circuit element each include at least one respective substantially linear portion.

According to another aspect of the present disclosure, a method for performing an entangling gate on a pair of quantum objects is provided. The pair of quantum objects is confined by a confinement apparatus at a defined location. The confinement apparatus is configured to confine a plurality of quantum objects, including the pair of quantum objects. The confinement apparatus includes at least one magnetic field control circuit (MFCC) and at least one magnetic field generator associated with the defined location. The defined location is defined at least in part by the confinement apparatus. In an example embodiment, the method includes causing the pair of quantum objects to be located at the defined location such that the pair of quantum objects experiences a static magnetic field gradient generated by the at least one magnetic field gradient source associated with the defined location. The method further includes controlling current provided to the at least one MFCC to cause the at least one MFCC to generate an applied magnetic field at the defined location that is in a direction that is aligned with a static quantization direction of a static quantization field associated with the confinement apparatus and that has an amplitude that is larger than an amplitude of the static quantization field. The static quantization direction defines a static quantization axis. The method further includes controlling the current provided to the at least one MFCC to cause the applied magnetic field generated by the at least one MFCC to rotate such that an experienced quantization field experienced by the quantum object disposed at the defined location rotates with a rotation frequency, wherein the rotation frequency corresponds to a motional mode of a quantum object of the plurality of quantum objects.

In an example embodiment, rotation of the experienced quantization field with the rotation frequency that corresponds to the motional mode of the quantum object causes the pair of quantum objects to experience a spin-dependent force.

In an example embodiment, the method further includes, when the experienced magnetic field is rotated an integer multiple of 360 degrees, controlling the circuit provide to the at least one MFCC to cause the amplitude of the applied magnetic field to decrease to less than the amplitude of the static quantization field while the quantization field remains aligned with the static quantization direction.

In an example embodiment, the integer multiple of 360 degrees corresponds to a gate time for performing the entangling gate.

In an example embodiment, the controller is configured to control the current provided to the at least one MFCC by controlling operation of a respective current and/or voltage source of the one or more current and/or voltage sources.

In an example embodiment, the controller comprises a non-transitory memory device and the method further comprises storing at least one of quantization field rotation information or entangling gate information corresponding to the rotation of the experienced quantization field or performance of the entangling gate in the non-transitory memory device in association with a quantum object identifier configured to identify the quantum object dispose at the defined location during the rotation of the experienced quantization field.

In an example embodiment, the quantum object is a qubit of a quantum computer comprising the confinement apparatus, and the entangling gate is performed during performance of a quantum circuit by the quantum computer.

In an example embodiment, the magnetic field generator comprises a permanent magnet or a permanent magnetic film.

According to another aspect, a system configured for performing an entangling gate on a pair of quantum objects is provided. In an example embodiment, the system includes a confinement apparatus configured to confine a plurality of quantum objects, including a pair of quantum objects. The confinement apparatus includes at least one magnetic field control circuit (MFCC) and at least one magnetic field generator associated with the defined location. The defined location is defined at least in part by the confinement apparatus. The system further includes a controller configured to control operation of the confinement apparatus. In an example embodiment, the controller is configured to cause the pair of quantum objects to be located at the defined location such that the pair of quantum objects experiences a static magnetic field gradient generated by the at least one magnetic field gradient source associated with the defined location. The controller is further configured to control current provided to the at least one MFCC to cause the at least one MFCC to generate an applied magnetic field at the defined location that is in a direction that is aligned with a static quantization direction of a static quantization field associated with the confinement apparatus and that has an amplitude that is larger than an amplitude of the static quantization field. The static quantization direction defines a static quantization axis. The controller is further configured to control the current provided to the at least one MFCC to cause the applied magnetic field generated by the at least one MFCC to rotate such that an experienced quantization field experienced by the quantum object disposed at the defined location rotates with a rotation frequency, wherein the rotation frequency corresponds to a motional mode of a quantum object of the plurality of quantum objects.

In an example embodiment, rotation of the experienced quantization field with the rotation frequency that corresponds to the motional mode of the quantum object causes the pair of quantum objects to experience a spin-dependent force.

In an example embodiment, the controller is further configured to, when the experienced magnetic field is rotated an integer multiple of 360 degrees, control the circuit provide to the at least one MFCC to cause the amplitude of the applied magnetic field to decrease to less than the amplitude of the static quantization field while the quantization field remains aligned with the static quantization direction.

In an example embodiment, the integer multiple of 360 degrees corresponds to a gate time for performing the entangling gate.

In an example embodiment, the system further includes one or more current and/or voltage sources and the controller is configured to control the current provided to the at least one MFCC by controlling operation of a respective current and/or voltage source of the one or more current and/or voltage sources.

In an example embodiment, the controller comprises a non-transitory memory device and the controller is further configured to store at least one of quantization field rotation information or entangling gate information corresponding to the rotation of the experienced quantization field or performance of the entangling gate in the non-transitory memory device in association with a quantum object identifier configured to identify the quantum object dispose at the defined location during the rotation of the experienced quantization field.

In an example embodiment, the quantum object is a qubit of a quantum computer comprising the confinement apparatus, and the entangling gate is performed during performance of a quantum circuit by the quantum computer.

In an example embodiment, the magnetic field generator comprises a permanent magnet or a permanent magnetic film.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a schematic diagram of an example quantum computing system, according to various embodiments;

FIG. 2 provides a schematic diagram of an example controller of a quantum computer, according to various embodiments;

FIG. 3 provides a schematic diagram of an example computing entity of a quantum computer system that may be used in accordance with an example embodiment;

FIG. 4 illustrates an example magnetic field control circuit (MFCC) formed on and/or in a chip housing a confinement apparatus, in accordance with an example embodiment;

FIG. 5 is a flowchart illustrating processes, procedures, and/or operations for performing pulsed passive dynamical decoupling of magnetic field sensitive sublevels of a quantum object, according to an example embodiment;

FIG. 6 is a schematic diagram illustrating various aspects of performance of the pulsed passive dynamical decoupling sequence, according to an example embodiment;

FIG. 7 is a flowchart illustrating processes, procedures, and/or operations for performing continuous passive dynamical decoupling of magnetic field sensitive sublevels of a quantum object, according to an example embodiment;

FIG. 8 is a schematic diagram illustrating various aspects of performance of the continuous passive dynamical decoupling sequence, according to an example embodiment; and

FIG. 9 is a flowchart illustrating processes, procedures, and/or operations for performing an entangling gate using passive dynamic decoupling, according to an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits/tolerances and/or within user measurement capabilities, unless otherwise indicated. Like numbers refer to like elements throughout.

Example embodiments relate to systems, apparatuses, methods, computer program products, and/or the like for performing passive dynamical decoupling of magnetic field sensitive sublevels of a quantum object confined by a confinement apparatus. In various embodiments, the quantum object is a neutral or ionic atom; neutral, ionic, and/or multipole molecule; quantum dot; and/or other quantum particle. In various embodiments, the confinement apparatus is configured to confine and/or trap one or more quantum objects. In an example embodiment, the quantum object is an ion and the confinement apparatus is an ion trap, such as a surface ion trap.

In various embodiments, the quantum object is a qubit or a qudit of a quantum computer (e.g., a quantum charge-coupled device (QCCD)-based quantum computer). A qubit is a two-state quantum-mechanical system used for storing quantum information. For example, in various embodiments a two-state sub-space of the quantum object energy structure is defined for storing quantum information. A qudit is a quantum-mechanical system having a d-state sub-space of the quantum object energy structure defined for storing quantum information, where d is a positive integer.

In various embodiments, a quantum object is confined at a defined location of a confinement apparatus. The confinement apparatus is associated with a static quantization field which is a magnetic field that is substantially uniform in direction and amplitude across the confinement apparatus and that is substantially constant and/or unchanging with time during performance of an experiment and/or controlled quantum state evolution using one or more quantum objects confined by the confinement apparatus. A set of states and/or hyperfine sublevels of the quantum object are defined based on the static quantization field. For example, the direction of the static quantization field defines a direction (e.g., a quantization direction) which is then used to further define the coordinate system used to define the set of hyperfine sublevels of the quantum object.

The confinement apparatus includes one or more magnetic field control circuits (MFCCs) that are operable to generate an applied magnetic field at the defined location. In an example embodiment, the operation of the MFCCs is controlled to cause performance of passive dynamical decoupling of magnetic field sensitive sublevels of the quantum object disposed at the defined location. In various embodiments, performing a passive dynamical decoupling sequence includes generating an applied magnetic field using the MFCCs such that the quantum object disposed at the defined location experiences an experienced quantization field which is the combination of the applied magnetic field and the static quantization field. The operation of the MFCCs is then controlled to cause the experienced quantization field to rotate in an adiabatic manner. For example, in various embodiments, an angular velocity of the rotation of the experienced quantization field is less than two pi times a frequency difference between adjacent hyperfine sublevels of the quantum object.

In various embodiments, a pulsed passive dynamical decoupling sequence is performed. In various embodiments, performance of a pulsed passive dynamical decoupling sequence causes passive dynamical decoupling of magnetic field sensitive states of a quantum object. In various embodiments performance of a passive dynamical decoupling sequence includes causing the experienced quantization field to rotate from being aligned with a direction of the static quantization field through 180 degrees such that the experienced quantization field and the static quantization field are in opposite directions. The applied magnetic field is then reduced in amplitude while maintaining the experienced quantization field as being parallel to a static quantization axis defined by the direction of the static quantization field. The performance of the pulsed passive dynamical decoupling sequence ends with the experienced quantization field being aligned with (and possibly of the same amplitude) the static quantization field. Performance of the pulsed passive dynamical decoupling sequence causes the hyperfine sublevel energy dependence of magnetic field sensitive sublevels (e.g., hyperfine sublevels of the quantum object where the energy of the sublevel has a linear dependence on magnetic field amplitude) to change sign. This can enable the time-averaged magnetic field noise accumulated by the quantum object to cancel out and/or be reduced.

In various embodiments, a continuous passive dynamical decoupling sequence is performed. In various embodiments, performance of a continuous passive dynamical decoupling sequence causes passive dynamical decoupling of magnetic field sensitive states of a quantum object. In various embodiments, performance of a continuous passive dynamical decoupling sequence includes causing the experienced quantization field to rotate from being aligned with a direction of the static quantization field through an integer multiple of 360 degrees. While the experienced quantization field is rotating, the hyperfine sublevel energy dependence of magnetic field sensitive sublevels continuously evolves in a symmetric manner such that the time-averaged magnetic field noise accumulated by the quantum object during performance of the continuous passive dynamical decoupling sequence is approximately zero and/or quite small.

In various instances, hyperfine sublevels of quantum objects are used as information carrying states of a qubit or qudit of a quantum processor. For example, a qubit/qudit sub-space of the energy structure of quantum object may be defined where the qubit/qudit states of the qubit/qudit subspace are hyperfine sublevels. In general, the respective energies/frequencies of hyperfine sublevels of a quantum object are dependent on the magnetic field being experienced by the quantum object. Thus, stray magnetic fields in the vicinity of the quantum processor can cause the qubits/qudits in the quantum processor to experience errors. For example, magnetic field noise may accumulate during the performance of a quantum circuit and cause errors. Therefore, technical problems exist regarding how to mitigate or prevent errors in quantum computations and/or other experiments caused by magnetic field noise.

Various embodiments provide technical solutions to these technical challenges. For example, various embodiments provide pulsed passive dynamical decoupling of magnetic field sensitive sublevels of a quantum object. Performance of a pulsed passive dynamical decoupling sequence causes the dependence of the energy/frequency of magnetic field sensitive sublevels of the quantum object to change signs (e.g., go from being positive to negative or vice versa). Therefore, if a quantum object spends approximately equal time in a configuration where the dependence of the energy/frequency of a first magnetic field sensitive sublevel of the quantum object is positive and in a configuration where the dependence of the energy/frequency of the first magnetic field sensitive sublevel of the quantum object is negative, the accumulated magnetic field noise and/or time-averaged magnetic field noise experienced by the quantum object will be approximately zero.

In another example, various embodiments provide continuous passive dynamical decoupling of magnetic field sensitive sublevels of a quantum object. Performance of a continuous passive dynamical decoupling sequence causes the dependence of the energy/frequency of magnetic field sensitive sublevels of the quantum object to continuously evolve in a symmetric manner such that the accumulated and/or time averaged magnetic field noise experience by the quantum object during the performance of the continuous passive dynamical decoupling sequence will be approximately zero.

Moreover, various embodiments cause performance of dynamical decoupling of all of the magnetic field sensitive sublevels of the quantum object, rather than just a selected pair of states. For example, a pulsed passive dynamical decoupling sequence drives the transition m->-m for the magnetic quantum number m of every quantum state of the quantum object. Additionally, knowledge of the stray magnetic fields in the vicinity of the quantum processor is not required for performance of the passive dynamical decoupling sequence.

Therefore, various embodiments provide technical solutions to technical problems in the fields of atomic systems and quantum systems that use magnetic field sensitive sublevels and/or hyperfine sublevels of quantum objects. For example, various embodiments provide technical improvements in the field of quantum computing and quantum information.

### EXAMPLE QUANTUM COMPUTER

Various embodiments provide systems, apparatuses (such as system controllers), methods, computer program products and/or the like for performing passive dynamical decoupling in a variety of atomic systems and/or quantum systems. One example such system is a QCCD-based quantum computer. For example, a QCCD-based quantum computer may include a confinement apparatus configured to confine a plurality of quantum objects that are used as qubits/qudits of the quantum computer.

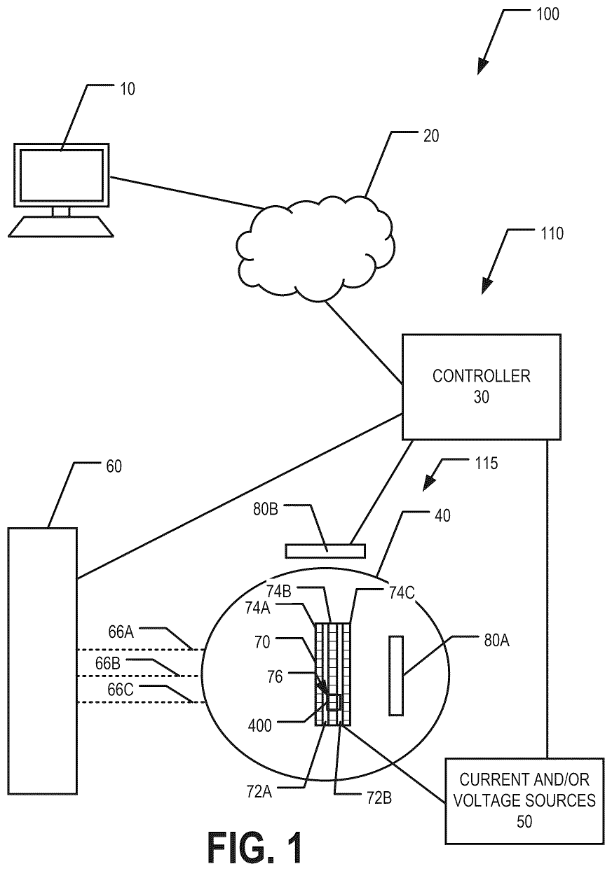

FIG. 1 provides a schematic diagram of an example quantum computing system 100 comprising a confinement apparatus 70 (e.g., an ion trap, surface trap, Paul trap, and/or the like), in accordance with an example embodiment. In various embodiments, the quantum computing system 100 comprises a computing entity 10 and a quantum computer 110. In various embodiments, the quantum computer 110 comprises a controller 30 and a quantum processor 115. In various embodiments, the quantum processor 115 comprises a confinement apparatus 70 enclosed in a cryostat and/or vacuum chamber 40, one or more current and/or voltage sources 50, one or more manipulation sources 60, one or more magnetic field generators 80 (e.g., 80A, 80B), one or more magnetic field control circuits (MFCC) 400, and/or the like.

In the illustrated embodiment, the confinement apparatus 70 comprises radio frequency (RF) rail electrodes 72 (e.g., 72A, 72B) and sequences of control electrodes 74 (e.g., 74A, 74B, 74C). In various embodiments, the RF rail electrodes 72 and control electrodes 74 define a one-dimensional confinement apparatus or a two-dimensional confinement apparatus.

Some non-limiting example confinement apparatuses are described by U.S. Pat. No. 11,037,776, issued Jun. 15, 2021; US Patent Publication No. 2022/0199391, published Jun. 23, 2022; and US Patent Publication No. 2023/0057368, published Feb. 23, 2023, the contents of which are incorporated by reference in their entireties herein.

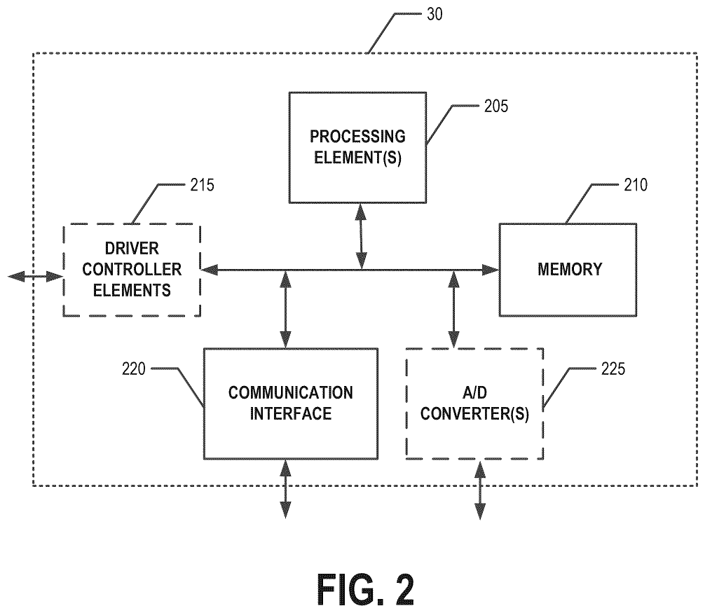

In an example embodiment, the one or more manipulation sources 60 comprise one or more lasers (e.g., optical lasers, microwave sources, and/or the like). In various embodiments, the one or more manipulation sources 60 are configured to manipulate and/or cause a controlled quantum state evolution of one or more quantum objects within the confinement apparatus 70. For example, the one or more manipulation sources 60 comprise respective manipulation sources 60 configured to generate and provide the respective manipulation signals configured to perform respective operations on one or more quantum objects. In an example embodiment, at least some of the manipulation signals are laser beams, laser pulse trains, and/or the like. For example, in an example embodiment wherein the one or more manipulation sources 60 comprise one or more lasers, the lasers may provide one or more laser beams to the confinement apparatus within the cryostat and/or vacuum chamber 40 via respective beam/signal delivery systems 66 (e.g., 66A, 66B, 66C). In various embodiments, a beam/signal delivery system 66 comprises one or more optical elements, photonic integrated circuits (PICs), optical fibers, free space optical elements, waveguides, and/or the like. The laser beams may be used to perform various operations (e.g., parallel operations), such as enacting one or more quantum gates on one or more qubits/qudits and/or quantum objects, sympathetic cooling of one or more quantum objects, reading a qubit/qudit and/or determining a quantum state of a quantum object, initializing a quantum object into the qubit/qudit sub-space, and/or the like. In various embodiments, the manipulation sources 60 are controlled by respective driver controller elements 215 (see FIG. 2) of the controller 30.

In various embodiments, the quantum computer 110 comprises one or more current and/or voltage sources 50. For example, the current and/or voltage sources 50 may comprise a plurality of control voltage drivers and/or voltage sources, at least one RF driver and/or voltage source, and at least one current source. The current and/or voltage sources 50 may be electrically coupled to the corresponding electrical components of the confinement apparatus 70. For example, the control voltage drivers and/or voltage signals are configured to provide respective voltage signals to potential generating elements of the confinement apparatus 70. For example, the current and/or voltage sources 50 are configured to provide (RF) oscillating voltage signals to the RF rail electrodes and RF bus electrodes of the confinement apparatus 70. For example, the current and/or voltage sources 50 are configured to provide controlling voltage signals to the control electrodes of the sequences of control electrodes 74. In another example, the current and/or voltage sources 50 are configured to provide controllable currents to the circuit elements of one or more MFCCs 400 of the confinement apparatus 70. In various embodiments, the current and/or voltage sources 50 are controlled by respective driver controller elements 215 of the controller 30.

In various embodiments, the quantum computer 110 comprises one or more magnetic field generators 80 (e.g., 80A, 80B). For example, the magnetic field generators may include one or more internal magnetic field generators 80A disposed within the cryogenic and/or vacuum chamber 40 and/or one or more external magnetic field generators 80B disposed outside of the cryogenic and/or vacuum chamber 40. In various embodiments, the magnetic field generators 80 are permanent magnets, Helmholtz coils, electrical magnets, and/or the like. In various embodiments, the magnetic field generators 80 are configured to generate a magnetic field at one or more regions of the quantum object confinement apparatus 70 that has a particular magnitude and a particular magnetic field direction in the one or more regions of the quantum object confinement apparatus 70. In particular, the magnetic field generators 80 are configured to generate a static quantization field which is a magnetic field that is substantially uniform in direction and amplitude across the confinement apparatus 70. In various embodiments, the magnetic field generators 80 are configured to generate a static quantization field that is substantially spatially uniform across the confinement apparatus and substantially temporally uniform during the time when the quantum processor 115 is being operated. In an example embodiment, the amplitude of the static quantization field is in a range of 1 to 10 Gauss (e.g., 2-5 Gauss). In an example embodiment, operation of the one or more magnetic field generators 80 is controlled by the controller 30. In an example embodiment, at least one of the magnetic field generators 80 is a permanent magnet and therefore is not controlled by the controller 30.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum circuits, quantum computing algorithms, and/or the like into a computing language, executable instructions, command sets, and/or the like that the controller 30 can understand and/or implement.

In various embodiments, the controller 30 is configured to control the current and/or voltage sources 50, cryogenic system and/or vacuum system controlling the temperature and pressure within the cryostat and/or vacuum chamber 40, manipulation sources 60, magnetic field generators 80, and/or other systems controlling various environmental conditions (e.g., temperature, pressure, and/or the like) within the cryostat and/or vacuum chamber 40 and/or configured to manipulate and/or cause a controlled evolution of quantum states of one or more quantum objects within the quantum object confinement apparatus 70. For example, the controller 30 may cause a controlled evolution of quantum states of one or more quantum objects within the quantum object confinement apparatus 70 to execute a quantum circuit and/or algorithm. For example, the controller 30 is configured to execute a quantum circuit comprising one or more general gates and/or one or more global gates, in various embodiments.

In various embodiments, the quantum objects confined within the quantum object confinement apparatus 70 are used as qubits/qudits of the quantum computer 110 and/or quantum processor 115. For example, the quantum processor 115 may include a plurality of object crystals that each comprise a first quantum object used as a qubit/qudit quantum object of the quantum processor (embodying a qubit/qudit of the quantum processor 115) and a second quantum object used as a sympathetic cooling quantum object for use in cooling the qubit/qudit quantum object of the same object crystal.

### Example Controller

In various embodiments, a quantum computer 110 comprises a controller 30 and a quantum processor 115. The controller 30 is configured to control various components of a quantum processor 115. For example, various embodiments are configured to perform passive dynamic coupling such as pulsed passive dynamical decoupling and/or continuous passive dynamical decoupling to reduce the sensitivity of one or more qubits/qudits of the quantum processor to magnetic field noise.

In various embodiments, the controller 30 is in communication with an optics collection system such that the controller 30 is configured to receive input data captured and/or generated by the optics collection system. For example, the optics collection system is configured to detect light/photons emitted and/or fluoresced by quantum objects used as the qubits/qudits of the quantum processor 115 and provide corresponding signals to the controller 30. The controller 30 is further configured to control operation of the current and/or voltage sources 50 to control operation of one or more MFCCs to cause performance of passive dynamical decoupling on one or more quantum objects. In various embodiments, the controller 30 is further configured to control a cryostat system and/or vacuum system controlling the temperature and pressure within the cryostat and/or vacuum chamber 40, cooling system, and/or other systems controlling the environmental conditions (e.g., temperature, humidity, pressure, and/or the like) within the cryostat and/or vacuum chamber 40.

As shown in FIG. 2, in various embodiments, the controller 30 may comprise various controller elements including processing element(s) 205, memory 210, driver controller elements 215, a communication interface 220, analog-digital (A/D) converter(s) 225, and/or the like. In various embodiments, the controller 30 is configured to receive input data generated by the optics collection system via the A/D converter(s) 225. In various embodiments, the processing element(s) 205 are configured to operate as described herein. In various embodiments, the controller 30 may include additional controller elements as described herein, that are configured to perform various functions described herein, and/or that are configured to perform additional functions of the controller 30.

In various embodiments, the processing element(s) 205 comprise processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing elements and/or circuitry, and/or the like. The term circuitry may refer to an entirely hardware embodiment or a combination of hardware and computer program products. In an example embodiment, a processing element 205 of the controller 30 comprises a clock and/or is in communication with a clock.

In various embodiments, the memory 210 comprises non-transitory memory such as volatile and/or non-volatile memory storage such as one or more of hard disks, ROM, PROM, EPROM, EEPROM, flash memory, MMCs, SD memory cards, memory sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 210 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 210 (e.g., by a processing element 205) causes the controller 30 to perform one or more steps, operations, processes, procedures and/or the like for generating one or more sets of commands configured to cause the quantum processor 115 to perform at least a portion of a quantum circuit; to update one or more (classical) qubit registries stored in memory 210; perform one or more passive dynamical decoupling sequences; and/or the like. In an example embodiment, execution of at least a portion of the computer program code stored in the memory 210 causes the controller 30 to cause one or more commands to be performed.

In various embodiments, the driver controller elements 215 include one or more drivers and/or controller elements each configured to control one or more drivers. In various embodiments, the driver controller elements 215 may comprise drivers and/or driver controllers. For example, the driver controllers may be configured to cause one or more corresponding drivers to be operated in accordance with executable instructions, commands, and/or the like generated, scheduled. and executed by the controller 30. For example, the processing element 205 may generate one or more commands to be performed by one or more driver controller elements 215.

In various embodiments, the driver controller elements 215 enable the controller 30 to operate and/or control operation of the current and/or voltage sources 50, manipulation sources 60, cooling systems, vacuum systems, and/or the like. In various embodiments, the drivers may be laser drivers (e.g., configured to operate and/or control one or more manipulation sources 60); vacuum component drivers; drivers for controlling the flow of current and/or voltage applied to electrodes and/or circuit elements of MFCCs (e.g., configured to operate and/or control one or more current and/or voltage sources 50) used for maintaining and/or controlling the trapping potential of the confinement apparatus 120 (and/or other drivers for providing driver action sequences to potential generating elements of the confinement apparatus); cryostat and/or vacuum system component drivers; cooling system drivers, and/or the like.

Each driver controller element 215 corresponds to an endpoint within the system (e.g., a component of a manipulation source 60, a component of a current and/or voltage source 50 (radio frequency voltage sources, arbitrary waveform generators (AWG), direct digital synthesizer (DDS), and/or other waveform generator), a component of a cooling and/or vacuum system, a component of the optics collection system, and/or the like). Each endpoint within the quantum computer 110 represents an individual hardware control. Each endpoint has its own set of accepted micro-commands, in various embodiments. Examples include but are not limited to a current and/or voltage source 50 such as a direct digital synthesizer (DDS), component of an optics collection system such as a photomultiplier tube (PMT) or photodiode, a component of a manipulation source 60 such as a laser driver and/or optical modulator switch, and/or general-purpose output (GPO). Individual commands for a DDS allow for setting power level, frequency and phase of a controlling signal generated thereby. Commands for a PMT or photodiode interface include start/stop photon count and reset of count, in various embodiments. Commands for a GPO endpoint include setting and/or clearing one or more output lines, in various embodiments. These output lines can be used to control external hardware in a manner synchronized with the quantum circuit execution.

In various embodiments, the controller 30 comprises means for communicating and/or receiving signals from one or more optical receiver components (e.g., of the optics collection system). For example, the controller 30 may comprise one or more analog-digital (A/D) converters 225 configured to receive signals from one or more optical receiver components (e.g., a photodetector of the optics collection system), calibration sensors, and/or the like. In various embodiments, the A/D converters 225 are configured to write the input data generated by converting the received signals generated by one or more optical receiver components (e.g., photodetectors) of the optics collection system to memory 210.

In various embodiments, the controller 30 may comprise a communication interface 220 for interfacing and/or communicating with, for example, a computing entity 10. For example, the controller 30 may comprise a communication interface 220 for receiving executable instructions, command sets, and/or the like from the computing entity 10 and providing output received from the quantum computer 110 (e.g., from an optics collection system) and/or the result of a processing the output to the computing entity 10. In various embodiments, the computing entity 10 and the controller 30 may communicate via a direct wired and/or wireless connection and/or via one or more wired and/or wireless networks 20.

### Example Computing Entity

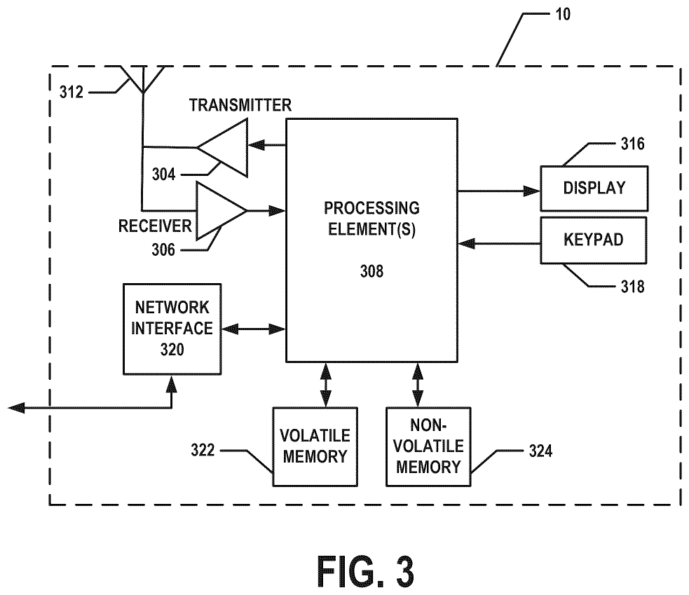

FIG. 3 provides an illustrative schematic representative of an example computing entity 10 that can be used in conjunction with embodiments of the present disclosure. In various embodiments, a computing entity 10 is a classical (e.g., semiconductor-based) computer configured to allow a user to provide input to the quantum computer 110 (e.g., via a user interface of the computing entity 10) and receive, display, analyze, and/or the like output from the quantum computer 110.

As shown in FIG. 3, a computing entity 10 can include an antenna 312, a transmitter 304 (e.g., radio), a receiver 306 (e.g., radio), and a processing element 308 that provides signals to and receives signals from the transmitter 304 and receiver 306, respectively. The signals provided to and received from the transmitter 304 and the receiver 306, respectively, may include signaling information/data in accordance with an air interface standard of applicable wireless systems to communicate with various entities, such as a controller 30, other computing entities 10, and/or the like. The computing entity 10 can include a network interface 320, which may provide signals to and receive signals in accordance with an interface standard of applicable network systems to communicate with various entities, such as a controller 30, other computing entities 10, and/or the like.

In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol.

Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may also comprise a user interface device comprising one or more user input/output interfaces (e.g., a display 316 and/or speaker/speaker driver coupled to a processing element 308 and a touch screen, keyboard, mouse, and/or microphone coupled to a processing element 308). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 322 and/or non-volatile storage or memory 324, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Example Magnetic Field Control Circuit (mfcc)

In various embodiments, any suitable circuitry may be used to generate a magnetic field having a desired magnitude and a desired direction to act upon a defined location of a confinement apparatus. Such circuitry may be termed a magnetic field control circuit (MFCC). For example, as described above, an MFCC may include one or more circuit elements that are arranged and/or configured to generate a magnetic field having a desired magnitude and a desired direction at the defined location. The terms magnitude and amplitude are used interchangeably herein to refer to the strength of the magnetic field.

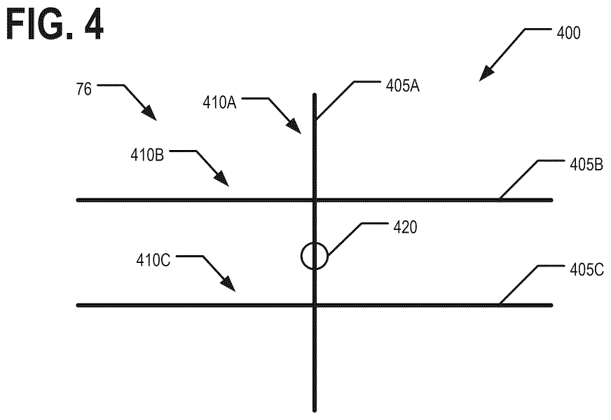

In an example embodiment, an MFCC comprises a plurality of circuit elements that are independent circuits such that the current provided to each circuit element is controlled independently of the current provided to any of the other circuit elements such that the combined magnetic field generated by the operation of the plurality of circuit elements is a magnetic field having a desired magnitude and a desired direction at the defined location. In various embodiments, the magnitude and the direction of the generated magnetic field are based on the magnitude and the direction of the current flowing through one or more circuit elements of the MFCC. In various embodiments, the one or more circuit elements of the MFCC are lithographically printed circuits on a chip 76 (as shown in FIG. 4) that houses the confinement apparatus (e.g., on which the control electrodes and RF rail electrodes are formed and/or disposed).

FIG. 4 illustrates an example MFCC 400 that comprises three individual and independent circuit elements 405 (e.g., 405A, 405B, 405C). The example MFCC 400 comprises a first circuit element 405A, a second circuit element 405B, and a third circuit element 405C.

The first circuit element 405A comprises a respective linear portion 410A that is substantially parallel to the RF rail electrodes 72 at the defined location. For example, the linear portion 410A is substantially aligned with and/or parallel to a one-dimensional trapping region that includes the defined location 420. The second circuit element 405B comprises respective linear portion 410B that is transverse and/or perpendicular to the linear portion 410a of the first circuit element 405A. For example, the linear portion 410B of the second circuit element 405B is substantially transverse and/or perpendicular to the RF rail electrodes 72 and/or the corresponding one-dimensional trapping region at the defined location 420. The third circuit element 405C comprises a respective linear portion 410C that is substantially parallel to the linear portion 410B of the second circuit element 405B. For example, the linear portion 410C of the third circuit element is substantially transverse and/or perpendicular to the RF rail electrodes 72 and/or the corresponding one-dimensional trapping region at the defined location 420. The defined location 420 is disposed between the respective linear portions 410B, 410C of the second circuit element 405B and the third circuit element 405C. In an example embodiment, the defined location 420 is within a plane defined at least in part by the linear portion 410A of the first circuit element 405A and that is perpendicular to the surface of the chip 76 housing the confinement apparatus 70.

In various embodiments, the MFCC 400 may include various numbers of circuit elements 405, which may or may not include respective linear portions 410, in various configurations with respect to the defined location 420 and the RF rail electrodes 72.

In various embodiments, the defined location 420 is a zone or region of the confinement apparatus 70 configured for the performance of one or two qubit/qudit gates, qubit/qudit reading operations, and/or the like on one or more quantum objects.

The example MFCC 400 is positioned such that the applied magnetic field generated by operation of the MFCC 400 acts upon the defined location 420 of the confinement apparatus 70 and upon the desired quantum object(s) located thereat. Generally, quantum objects are confined about 30-80 microns above the surface of the confinement apparatus 70. As such, the example MFCC 400 of various embodiments is configured and positioned to generate the desired applied magnetic field at about 30-80 microns above the surface of the confinement apparatus 70.

In various embodiments, the direction and the magnitude of the current flowing through each of the first, second, and third circuit elements 405 may be separately and/or independently controlled to provide the magnitude and the direction (on an x, y, z coordinate system) of the applied magnetic field generated by the MFCC 400. In various embodiments, the currents provided and/or applied to each of the circuit elements 405 are quasi-direct currents. A quasi-direct current is a direct current that may change in a periodic or non-periodic manner on a time frame that is long compared to the frequency of the voltage signal provided to the RF rail electrodes, in various embodiments.

In various embodiments in which a static quantization field is present, the applied magnetic field generated by the MFCC will combine with the static quantization field as a vector sum to provide an experienced quantization field, which is experienced by the quantum object(s) disposed at the defined location 420. In such embodiments, the magnitude and direction of the currents applied to the MFCC are selected and/or controlled such that the experienced quantization field has the desired magnitude and direction.

In various embodiments, the MFCC 400 is similar to the quantization field control circuit disclosed in U.S. Application No. 63/525,300, filed Jul. 6, 2023, the content of which is incorporated herein by reference in its entirety.

### Example Passive Dynamical Decoupling Sequence

In various embodiments, a passive dynamical decoupling sequence is performed on one or more quantum objects disposed at a defined location of a confinement apparatus 70. For example, in various embodiments, a passive dynamical decoupling sequence is performed by rotating the experienced quantization field experienced by one or more quantum objects disposed at the defined location. For example, in various embodiments, the MFCC 400 is operated to generate an applied magnetic field such that the one or more quantum objects disposed at the defined location experience an experienced quantization field that is in the same direction as, parallel to, and/or aligned with the static quantization field. The amplitude of the applied magnetic field is larger than the magnitude of the static quantization field such that the experienced magnetic field is dominated by the applied magnetic field. The MFCC 400 is then operated to cause the applied magnetic field to rotate. Rotation of the applied magnetic field causes the experienced quantization field to rotate as well.

In various embodiments, the rotation of the experienced quantization field is adiabatic. As used herein, the rotation of the experienced quantization field is adiabatic means that the environment of a quantum object changes sufficiently slowly such that the quantum object does not undergo transitions as a result of the change in the experienced quantization field. For example, the quantum object adapts to the new environment such that the nature of the quantum states of the quantum object changes accordingly. For example, the angular velocity of the rotation of the experienced quantization field is less than two pi times a frequency difference between adjacent hyperfine sublevels of the quantum object.

In various embodiments, one or more pulsed passive dynamical decoupling sequences are performed on one or more quantum objects during the performance of a quantum circuit. In various embodiments, performing a pulsed passive dynamical decoupling sequence on a quantum object comprises causing the experienced quantization field at the defined location where the quantum object is disposed to rotate 180 degrees (e.g., from being in a same direction as the static quantization field to a direction that is opposite the direction of the static quantization field) and then reducing the applied magnetic field while maintaining the direction of the experienced quantization field along a quantization field axis defined by the direction of the static quantization field until the experienced quantization field dominated by the static quantization field and/or in the same direction as the static quantization field. In various embodiments, performing a pulsed passive dynamical decoupling sequence on a quantum object causes the causes the hyperfine sublevel energy dependence of magnetic field sensitive sublevels (e.g., hyperfine sublevels of the quantum object where the energy of the sublevel has a linear dependence on magnetic field) to change sign.

For example, the energy of a hyperfine sublevel of magnetic field sensitive sublevel of the quantum object may scale as a*B, where B is the amplitude of the magnetic field at the location of the quantum object and a is a constant (e.g., ∂a/∂B=0), when the quantum object is in a first configuration. When the quantum object is in the first configuration prior to performance of the pulsed passive dynamical decoupling sequence, the quantum object is in a second configuration after and/or as a result of performance of the pulsed passive dynamical decoupling sequence. In the second configuration, the energy of a hyperfine sublevel of magnetic field sensitive sublevel of the quantum object may scale as −a*B. When the quantum object is in the second configuration prior to performance of the pulsed passive dynamical decoupling sequence, the quantum object is in the first configuration after and/or as a result of the performance of the pulsed passive dynamical decoupling sequence.

In various embodiments, one or more pulsed passive dynamical decoupling sequence may be performed on a quantum object during performance of a quantum circuit such that the quantum object spends approximately equal amounts of time in the first configuration and the second configuration. In an example embodiment, one or more pulsed passive dynamical decoupling sequence may be performed on a quantum object during performance of a quantum circuit such that the quantum object spends approximately equal amounts of time when the quantum object is in a magnetic field sensitive sublevel in each of the first configuration and the second configuration. Thus, assuming that the magnitude of stray magnetic fields in the vicinity of the quantum processor is approximately constant and/or does not change significantly (e.g., by a factor of 2 or more, by a factor of 10 or more, and/or the like) during performance of the quantum circuit, the accumulated and/or time-averaged (e.g., over the time period when the quantum circuit is being performed) magnetic field noise experienced by the quantum object is small and/or approximately zero. Notably, this reduction of the accumulated and/or time-averaged magnetic field noise is independent of which (magnetic field sensitive sublevel) the quantum object is in as the passive dynamical decoupling sequence flips the magnetic field energy dependence of all magnetic field sensitive sublevels of the quantum object.

In various embodiments, one or more continuous passive dynamical decoupling sequences are performed on one or more quantum objects. In various embodiments, the one or more continuous passive dynamical decoupling sequences are performed while the quantum objects are in magnetic field sensitive sublevels (e.g., hyperfine sublevels of the quantum object where the energy of the sublevel has a linear dependence on magnetic field amplitude). For example, in various embodiments, the qubit/qudit states (e.g., the information carrying states) may be clock states of the quantum object (e.g., states that are not magnetic field sensitive sublevels). For performance of various functions (e.g., single or multiple qubit/qudit gates, reading operations, and/or the like) a quantum object may be shelved in a magnetic field sensitive sublevel. While the quantum object is shelved in the magnetic field sensitive sublevel, the continuous passive dynamical decoupling sequence may be performed to reduce the accumulated magnetic field noise during the time the quantum object is shelved in the magnetic field sensitive sublevel.

In various embodiments, performance of a continuous passive dynamical decoupling sequence comprises causing the experienced quantization field at the defined location where the quantum object is disposed to rotate an integer multiple of 360 degrees (e.g., starting and stopping in a same direction as the static quantization field). In various embodiments, performing a continuous passive dynamical decoupling sequence on a quantum object causes the causes the hyperfine sublevel energy dependence of magnetic field sensitive sublevels (e.g., hyperfine sublevels of the quantum object where the energy of the sublevel has a linear dependence on magnetic field) to change continuously as the experienced quantization field rotates. The hyperfine sublevel energy dependence of magnetic field sensitive sublevels changes in a symmetric manner such that the accumulated magnetic field noise during performance of the continuous passive dynamical decoupling sequence is small and/or approximately zero.

### Example Pulsed Passive Dynamical Decoupling Sequence

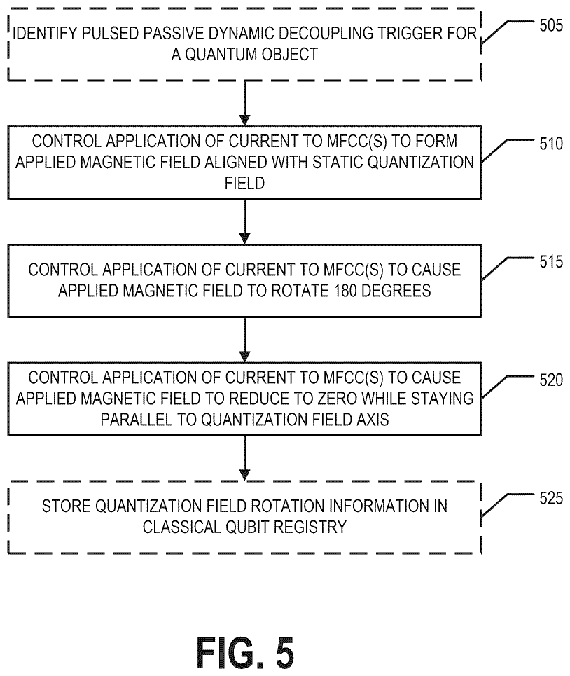

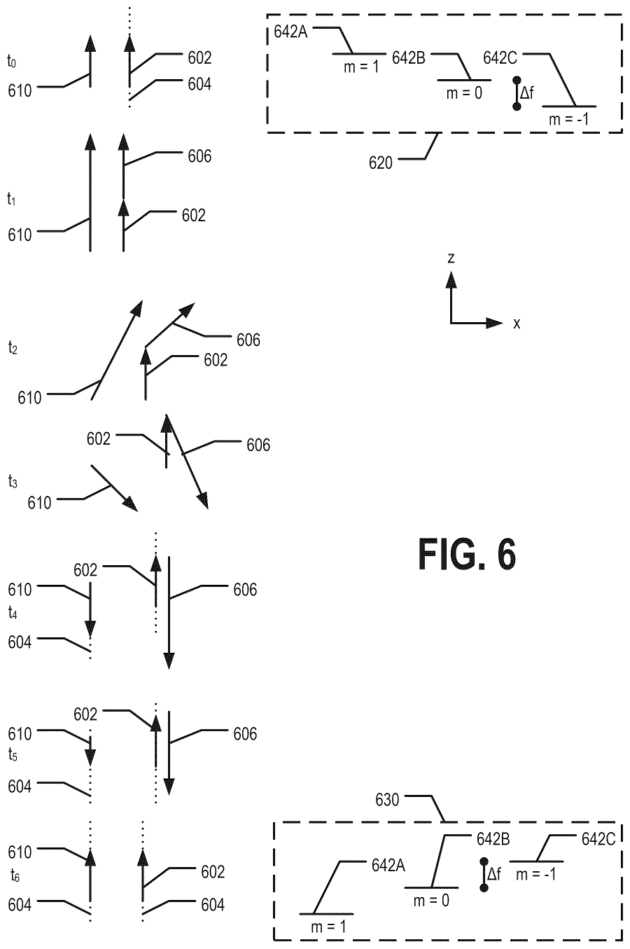

FIG. 5 provides a flowchart illustrating various processes, procedures, operations, and/or the like performed by a controller 30 of a quantum computing system 100 to perform a pulsed passive dynamical decoupling sequence, in various embodiments. FIG. 6 provides a schematic diagram illustrating a series of time steps of performing a pulsed passive dynamical decoupling sequence, according to an example embodiment.

Starting at step 505, a controller 30 identifies a pulsed passive dynamical decoupling sequence trigger for a quantum object. For example, the controller 30 comprises means, such as processing element 205, memory 210, communication interface 220, A/D converter 225, and/or the like, for identifying a pulsed passive dynamical decoupling sequence trigger for a quantum object. For example, the controller 30 may determine that a first half of a quantum circuit has been completed and, based thereon, identify a pulsed passive dynamical decoupling sequence trigger for one or more quantum objects such that the one or more quantum objects spend the first half of the quantum circuit in a first configuration and a second half of the quantum circuit in a second configuration.

In another example, a quantum circuit may be configured such that a quantum object spends a first half of the amount of time during a quantum circuit that the quantum object is in a magnetic field sensitive sublevel in the first configuration and the second half of the amount of time during the quantum circuit that the quantum object is in a magnetic field sensitive sublevel in the second configuration.

In another example, the quantum circuit may be configured such that a quantum object spends approximately half of the time during the quantum circuit in the first configuration and approximately half of the time during the quantum circuit in the second configuration, by breaking the time during which the quantum circuit is being performed into 2N time segments, N a positive integer. At the end of each of the 2N time segments, the controller 30 identifies a pulsed passive dynamical decoupling sequence trigger for one or more quantum objects.

In another example, the quantum circuit may be configured such that a quantum object spends approximately half of the time during which the quantum object is in a magnetic field sensitive sublevel during performance of the quantum circuit in the first configuration and approximately half of the time during which the quantum object is in a magnetic field sensitive sublevel during performance of the quantum circuit in the second configuration, by breaking the time during which the quantum object is in a magnetic field sensitive sublevel during performance of the quantum circuit is being performed into 2N time segments, N a positive integer. At the end of each of the 2N time segments, the controller 30 identifies a pulsed passive dynamical decoupling sequence trigger for one or more quantum objects.

In another example, the quantum circuit may be configured such that a quantum object spends approximately half of the number of times the quantum object is shelved to a magnetic field sensitive sublevel in the first configuration and approximately half of the number of times the quantum object is shelved to a magnetic field sensitive sublevel in the second configuration. For example, in an example embodiment, every other time or every m^{th} time, for a certain selection of m a positive integer, a quantum object is shelved to a magnetic field sensitive sublevel or deshelved from a magnetic field sensitive sublevel, a pulsed passive dynamical decoupling sequence trigger is identified for the quantum object.

Various embodiments may determine when a pulsed passive dynamical decoupling sequence should be performed on a quantum object as appropriate for the application.

At step 510, the controller 30 controls operation of the current and/or voltage sources 50 to cause application of one or more currents to the MFCC 400 (e.g., to respective ones of the circuit elements 405) to cause an applied magnetic field to be formed. For example, the controller 30 comprises means, such as processing element 205, memory 210, driver controller elements 215, and/or the like, for controlling operation of the current and/or voltage sources 50 to cause application of one or more currents to the MFCC 400 (e.g., to respective ones of the circuit elements 405) to cause an applied magnetic field to be formed. The applied magnetic field is aligned with the static quantization field. For example, the quantum object on which the pulsed passive dynamical decoupling sequence is to be performed is transported, if necessary, to a defined location 420 of the confinement apparatus 70. One or more currents are applied to the MFCC 400 associated with and/or corresponding to the defined location 420 to cause an applied magnetic field at the defined location 420 that is aligned with the static quantization field.

For example, as shown in FIG. 6, at an initial time t₀ a quantum object disposed at the defined location 420 experiences an experienced quantization field 610. The experienced quantization field 610 is substantially equal to the static quantization field 602. For example, the experienced quantization field 610 is in the same direction as the static quantization field 602 and has the same magnitude as the static quantization field 602.

At the initial time t₀, is in a first configuration 620. For example, the illustrated hyperfine sublevels 642A, 642B, 642C are in a same manifold and are separated in frequency and energy from one another as result of hyperfine structure of the quantum object. For example, the frequency difference between the second hyperfine sublevel 642B and the third hyperfine sublevel 642C is Δf, where the frequency of the second hyperfine sublevel 642B is higher than the frequency of the third hyperfine sublevel 642C by the frequency difference Δf.

At a first time t₁, an applied magnetic field 606 is generated by the MFCC 400 (e.g., by application of appropriate currents to the circuit elements 405A, 405B, 405C) that is in the same direction as the static quantization field 602. For example, the static quantization field 602 defines a static quantization axis 604 and the applied magnetic field 606 is parallel to the static quantization axis 604. The quantum object disposed at the defined location 420 experiences an experienced quantization field 610 that is the combination of the static quantization field 602 and the applied magnetic field 606. At the first time t₁, the experienced quantization field 610 is in the same direction as the static quantization field 602 and greater in amplitude than the static quantization field 602.

In various embodiments, the respective currents are applied to the circuit elements 405 such that the amplitude of the applied magnetic field 606 goes from being approximately zero and/or negligent compared to the static quantization field 602, to a first amplitude at time t₁ slowly. For example, amplitude of the applied magnetic field 606 increases slowly compared to the inverse of the frequency difference between adjacent hyperfine sublevels of the quantum object (e.g., 1/Δf). For example, the time required for the applied magnetic field 606 to increase from being approximately zero and/or negligent compared to the static quantization field 602, to a first amplitude at time t₁ occurs over a period of time that is longer than the inverse of the frequency difference between adjacent hyperfine sublevels of the quantum object (e.g., 1/Δf), in various embodiments. For example, the applied magnetic field 606 may be turned on (e.g., increase in amplitude from approximately zero and/or negligent compared to the static quantization field 602 to the first amplitude) adiabatically.

As used herein, two hyperfine sublevels of the quantum object are adjacent if they are in the same manifold, have the same F quantum number, and have magnetic quantum numbers m that differ by one. For example, hyperfine sublevels 642A, 642B, 642C are in the same manifold and have the same F quantum number. The first hyperfine sublevel 642A has magnetic quantum number m=1 and the second hyperfine sublevel 642B has magnetic quantum number m=0, so the first and second hyperfine sublevels are considered adjacent hyperfine sublevels of the quantum object. Similarly, the second hyperfine sublevel 642B has magnetic quantum number m=0 and the third hyperfine sublevel 642C has magnetic quantum number m=−1, so the second and third hyperfine sublevels are considered adjacent hyperfine sublevels of the quantum object. However, the first hyperfine sublevel 642A and the third hyperfine sublevel 642C are not considered adjacent because their magnetic quantum numbers m differ by two.

Returning to FIG. 5, at step 515, the controller 30 controls application current to the MFCC 400 (e.g., circuit elements 405) to cause the applied magnetic field 606 to rotate 180 degrees. In various embodiments, the magnitude of the applied magnetic field 606 remains larger than the magnitude of the static quantization field 602 while the applied magnetic field 606 is rotated 180 degrees. For example, rotating the applied magnetic field 606 180 degrees causes the experienced quantization field 610 to rotate 180 degrees. For example, the controller comprises means, such as processing element 205, memory 210, driver controller elements 215, and/or the like, for controlling application of current to the MFCC 400 to cause the applied magnetic field 606 rotate.

For example, as shown in FIG. 6, the applied magnetic field 606 rotates between the first time t₁ and a fourth time t₄ (e.g., a times t₁-t₄). The static quantization field 602 has a substantially constant magnitude and direction during the rotation of the applied magnetic field 606. The rotation of the applied magnetic field 606 causes the experienced quantization field 610 to rotate as well. For example, at the first time t₁, the experienced quantization field 610 is in the same direction as the static quantization field 602. At the fourth time t₄, the experienced quantization field 610 is parallel to the static quantization axis 604, but in an opposite direction compared to the static quantization field 602.

In various embodiments, the rotation of the experienced quantization field 610 is adiabatic. For example, the current applied to the MFCCs is controlled to cause the experienced quantization field 610 to rotate in an adiabatic manner. For example, in various embodiments, an angular velocity of the rotation of the experienced quantization field 610 is less than two pi times a frequency difference Δf between adjacent hyperfine sublevels of the quantum object. In another example, the time between the first time t₁ and the fourth time t₄ is greater than the inverse of the frequency difference Δf between adjacent hyperfine sublevels of the quantum object.

Returning to FIG. 5, at step 520, the controller 30 controls application of current to the MFCC 400 (e.g., respective currents to the circuit elements 405) to cause the applied magnetic field 606 to reduce in amplitude while remaining parallel to the static quantization axis 604. For example, the controller comprises means, such as processing element 205, memory 210, driver controller elements 215, and/or the like, for controlling application of current to the MFCC 400 to cause the applied magnetic field 606 to reduce in amplitude while remaining parallel to the static quantization axis 604.

In various embodiments, the amplitude of the applied magnetic field 606 is reduced to approximately zero and/or such that the applied magnetic field 606 is negligible compared to the static quantization field 602. In various embodiments, the amplitude of the applied magnetic field 606 is reduced such that the experienced quantization field 610 is approximately equal to the static quantization field 602.

As shown in FIG. 6, between the fourth time t₄ and a sixth time t₆ (e.g., times t₄-t₆), the currents provided to the circuit elements 405 of the MFCC 400 causes the magnitude of the applied magnetic field 606 to decrease while maintaining the direction of the applied magnetic field 606 as being parallel to the static quantization axis 604. In various embodiments, the amplitude of the applied magnetic field 606 is reduced so that at time t₆ the applied magnetic field 606 has zero amplitude and/or an amplitude that is negligible compared to the static quantization field 602 amplitude. In an example embodiment, at time t₆, the applied magnetic field 606 has a non-zero amplitude and a direction that is in the direction of the static quantization field 602.

In various embodiments, the time period over which the amplitude of the applied magnetic field 606 is reduced is shorter than the time period over which the amplitude of the applied magnetic field 606 was increased from (substantially) zero-amplitude to the first amplitude. For example, the time between the initial time t₀ and the first time t₁ is longer than the time between the fourth time t₄ and the sixth time t₆ (e.g., t₁-t₀>t₆-t₄). In various embodiments, the amount of time where the magnitude of the experienced quantization field 610 is less than 0.1 Gauss is less than a microsecond, less than half a microsecond, or less than a quarter of a microsecond.

At time t₆, the quantum object disposed at the defined location 420 is in a second configuration 630. In the second configuration, the frequency difference between the second hyperfine sublevel 642B and the third hyperfine sublevel 642C is still Δf. However, the frequency of the second hyperfine sublevel 642B is now lower than the frequency of the third hyperfine level 642C by the frequency difference Δf. For example, the second hyperfine sublevel is a clock state (e.g., not a magnetic field dependent hyperfine sublevel) and switching from the first configuration 620 to the second configuration 630 via the pulsed passive dynamical decoupling sequence has caused the magnetic field dependence of the energy/frequency of the third hyperfine sublevel 642C to change sign.

Thus, magnetic field noise accumulated by the quantum object while in the quantum object is in the second configuration 630 will be opposite in sign compared to the magnetic field noise accumulated by the quantum object while the quantum object is in the first configuration 620. Therefore, the performance of one or more pulsed passive dynamical decoupling sequences on the quantum object can cause the total, accumulated, and/or time-averaged magnetic field noise (e.g., over the time when a quantum circuit is performed) to be approximately zero.

Returning to FIG. 5, at step 525, the controller 30 may store quantization field rotation information in a classical qubit/qudit registry (e.g., stored in the memory 210). For example, in various embodiments, the memory 210 of the controller 30 may store a classical qubit/qudit registry. The classical qubit/qudit registry includes information regarding each qubit/qudit of the quantum processor. For example, the classical qubit/qudit registry may include an entry for each qubit/qudit of the quantum processor. A respective qubit/qudit entry of the classical qubit/qudit register is indexed by a qubit/qudit identifier configured to uniquely identify the qubit/qudit in the quantum circuit, a current location of the qubit/qudit, a phase accumulation tracker for the qubit/qudit, a heat accumulation tracker for the qubit/qudit, one or more software-based quantum error corrections for the qubit/qudit, and/or the like.

In various embodiments, a qubit/qudit registry corresponding to the quantum object disposed at the defined location 420 is updated to include quantization field rotation information corresponding to the performance of the pulsed passive dynamical decoupling sequence on the quantum object. For example, quantization field rotation information may include a time at which the pulsed passive dynamical decoupling sequence was performed, any trackable change in phase caused by the performance of the pulsed passive dynamical decoupling sequence on the quantum object, any noise accumulation caused by performance of the pulsed passive dynamical decoupling sequence on the quantum object, and/or other information corresponding to effects experienced by the quantum object as a result of the performance of the pulsed passive dynamical decoupling sequence on the quantum object. For example, the controller 30 comprises means, such as processing element 205, memory 210, and/or the like for updating the classical qubit/qudit registry with quantization field rotation information corresponding to the performance of the pulsed passive dynamical decoupling sequence performed on the quantum object disposed at the defined location 420.

In various embodiments, a pulsed passive dynamical decoupling sequence is performed on a single quantum object disposed at the defined location 420 at a time. In various embodiments, pulsed passive dynamical decoupling sequences are performed in parallel, simultaneously, and/or at least partially overlapping in time on a plurality of quantum objects each disposed at a respective one of a plurality of defined locations of the confinement apparatus. In various embodiments, a pulsed passive dynamical decoupling sequence is performed on two or more quantum objects disposed at the defined location 420 at the same time and/or simultaneously.

### Example Continuous Passive Dynamical Decoupling Sequence

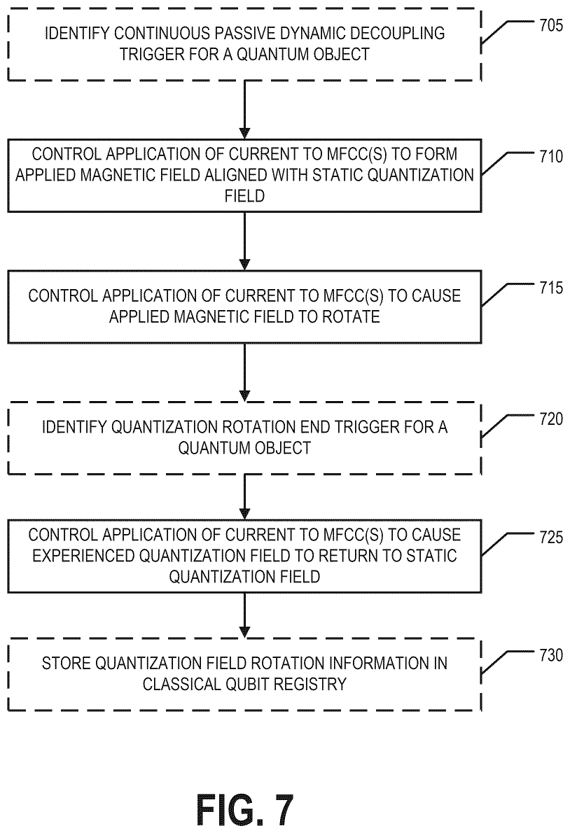

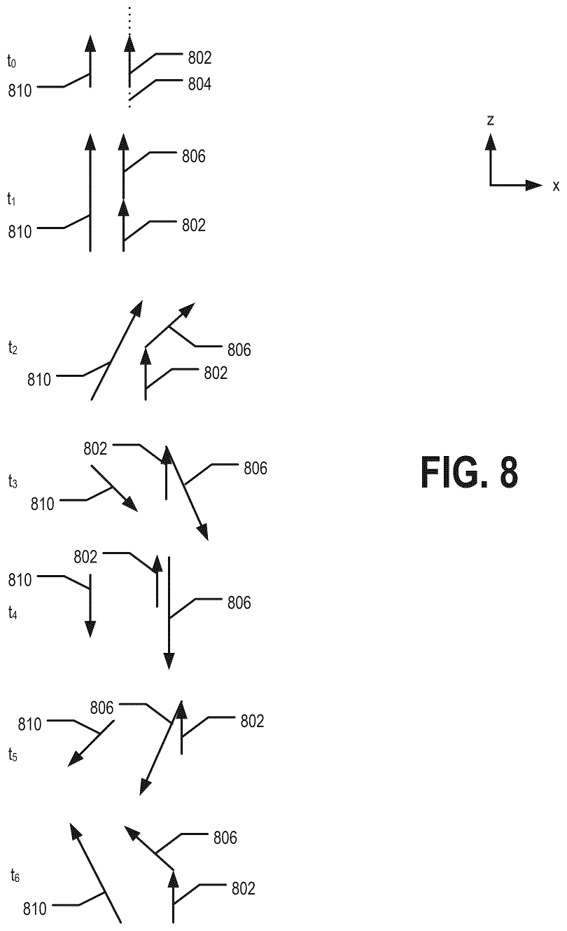

FIG. 7 provides a flowchart illustrating various processes, procedures, operations, and/or the like performed by a controller 30 of a quantum computing system 100 to perform a continuous passive dynamical decoupling sequence, in various embodiments. FIG. 8 provides a schematic diagram illustrating a series of time steps of performing a continuous passive dynamical decoupling sequence, according to an example embodiment.

Starting at step 705, a controller 30 identifies a continuous passive dynamical decoupling sequence trigger for a quantum object. For example, the controller 30 comprises means, such as processing element 205, memory 210, communication interface 220, A/D converter 225, and/or the like, for identifying a continuous passive dynamical decoupling sequence trigger for a quantum object. For example, the controller 30 may determine that the quantum object has been shelved and/or transitioned to a magnetic field sensitive sublevel or that the quantum object is to be shelved and/or transitioned to a magnetic field sensitive sublevel (e.g., from an information carrying clock state, for example) and, based thereon, identify a continuous passive dynamical decoupling sequence trigger for the quantum object. For example, the controller 30 may be configured to perform a continuous passive dynamical decoupling sequence on a quantum object that is in a magnetic field sensitive sublevel to prevent the quantum object from accumulating a large amount of magnetic field noise while in the magnetic field sensitive sublevel. Various embodiments may determine when a continuous passive dynamical decoupling sequence should be performed on a quantum object as appropriate for the application.

At step 710, the controller 30 controls operation of the current and/or voltage sources 50 to cause application of one or more currents to the MFCC 400 (e.g., to respective ones of the circuit elements 405) to cause an applied magnetic field to be formed. For example, the controller 30 comprises means, such as processing element 205, memory 210, driver controller elements 215, and/or the like, for controlling operation of the current and/or voltage sources 50 to cause application of one or more currents to the MFCC 400 (e.g., to respective ones of the circuit elements 405) to cause an applied magnetic field to be formed. The applied magnetic field is aligned with the static quantization field. For example, the quantum object on which the continuous passive dynamical decoupling sequence is to be performed is transported, if necessary, to a defined location 420 of the confinement apparatus 70. One or more currents are applied to the MFCC 400 associated with and/or corresponding to the defined location 420 to cause an applied magnetic field at the defined location 420 that is aligned with the static quantization field.

For example, as shown in FIG. 8, at an initial time t₀ a quantum object disposed at the defined location 420 experiences an experienced quantization field 810. The experienced quantization field 810 is substantially equal to the static quantization field 802. For example, the experienced quantization field 810 is in the same direction as the static quantization field 802 and has the same magnitude as the static quantization field 802. For example, at the initial time t₀ the amplitude of the applied magnetic field 806 is zero and/or negligible compared to the static quantization field 802.

At a first time t₁, an applied magnetic field 806 is generated by the MFCC 400 (e.g., by application of appropriate currents to the circuit elements 405A, 405B, 405C) that is in the same direction as the static quantization field 802. For example, the static quantization field 802 defines a static quantization axis 804 and the applied magnetic field 806 is parallel to the static quantization axis 804. The quantum object disposed at the defined location 420 experiences an experienced quantization field 810 that is the combination of the static quantization field 802 and the applied magnetic field 806. At the first time t₁, the experienced quantization field 810 is in the same direction as the static quantization field 802 and greater in amplitude than the static quantization field 802.

In various embodiments, the respective currents are applied to the circuit elements 405 such that the amplitude of the applied magnetic field 806 goes from being approximately zero and/or negligent compared to the static quantization field 802, to a first amplitude at time t₁ slowly. For example, amplitude of the applied magnetic field 806 increases slowly compared to the inverse of the frequency difference between adjacent hyperfine sublevels of the quantum object (e.g., 1/Δf). For example, the time required for the applied magnetic field 806 to increase from being approximately zero and/or negligent compared to the static quantization field 802, to a first amplitude at time t₁ occurs over a period of time that is longer than the inverse of the frequency difference between adjacent hyperfine sublevels of the quantum object (e.g., 1/Δf), in various embodiments. For example, the applied magnetic field 806 may be turned on (e.g., increase in amplitude from approximately zero and/or negligent compared to the static quantization field 802 to the first amplitude) adiabatically.

Returning to FIG. 7, at step 715, the controller 30 controls application of current to the MFCC 400 (e.g., circuit elements 405) to cause the applied magnetic field 806 to rotate. In various embodiments, the magnitude of the applied magnetic field 806 remains larger than the magnitude of the static quantization field 802 while the applied magnetic field 806 is rotated. For example, rotating the applied magnetic field 806 causes the experienced quantization field 810 to rotate. For example, the controller comprises means, such as processing element 205, memory 210, driver controller elements 215, and/or the like, for controlling application of current to the MFCC 400 to cause the applied magnetic field 806 rotate.

For example, as shown in FIG. 8, the applied magnetic field 806 rotates between the first time t₁ through a sixth time t₆ (e.g., a times t₁-t₆). The applied magnetic field 806 continues to rotate after the sixth time t₆ such that the experienced quantization field 810 rotates an integer number of times around a complete circle. For example, the applied magnetic field 806 continuously rotates such that the experienced quantization field 810 rotates a total of N*360 degrees, where N is a positive integer.

In various embodiments, the rotation of the experienced quantization field 810 is adiabatic with respect to the quantum object disposed at the defined location 420. For example, the current applied to the MFCCs is controlled to cause the experienced quantization field 810 to rotate in an adiabatic manner. For example, in various embodiments, an angular velocity of the rotation of the experienced quantization field 810 is less than two pi times a frequency difference Δf between adjacent hyperfine sublevels of the quantum object. In another example, the time required for the experienced quantization field to rotate 360 degrees is greater than the inverse of the frequency difference Δf between adjacent hyperfine sublevels of the quantum object.

Returning to FIG. 7, at step 720, the controller 30 may identify a quantization rotation end trigger for the quantum object. For example, the controller 30 may comprise means, such as processing element 205, memory 210, and/or the like for identifying a quantization rotation end trigger for the quantum object. For example, in various embodiments, the controller 30 is configured to cause the experienced quantization field 810 to rotate a total of N*360 degrees, where N is a positive integer, or N complete rotations. The number N may be preset such that the controller 30 identifying the quantization rotation end trigger when the applied magnetic field 806 begins the Nth rotation. In another example, the controller 30 may be configured to cause the experienced quantization field 810 to rotate for a set time period (e.g., the amount of time required to perform a quantum gate that requires the quantum object(s) on which the gate is being performed to be in a magnetic field sensitive sublevel). The controller 30 may determine when the set time period has elapsed since the rotation of the applied magnetic field 806 began and, based thereon, identify a quantization rotation end trigger. In various embodiments, the controller 30 may be configured to determine when to halt or stop the continuous rotation of the applied magnetic field 806 (and therefore of the experienced quantization field 810) in various manners, as appropriate for the application.

At step 725, the controller 30 controls application of current to the MFCC 400 (e.g., the circuit elements 405) to cause the experienced quantization field 810 to return to the static quantization field 802 (e.g., such that the experienced quantization field 810 is approximately equal to the static quantization field 802). For example, the controller 30 controls application of current to the MFCC 400 to cause the applied magnetic field 806 to stop rotating while the applied magnetic field 806 (and therefore the experienced quantization field 810) is aligned with and/or parallel to the static quantization field 802.

In various embodiments, the rotation of the applied magnetic field 806, and therefore the experienced quantization field 810, is ended adiabatically. For example, the angular speed of the rotation of the applied magnetic field 806 smoothly and continuously reaches zero when the applied magnetic field 806 is aligned with the static quantization field 802.

After the rotation of the applied magnetic field 806 has stopped (e.g., after rotation of N*360 degrees, N complete rotations, and/or such that the applied magnetic field 806 is parallel to and/or aligned with the static quantization field 802), the currents provided to the circuit elements 405 of the MFCC 400 causes the magnitude of the applied magnetic field 806 to decrease while maintaining the direction of the applied magnetic field 806 as being parallel to the static quantization field 802. In various embodiments, the amplitude of the applied magnetic field 806 is reduced until the applied magnetic field 806 has zero amplitude and/or an amplitude that is negligible compared to the static quantization field 802 amplitude. For example, the amplitude of the applied magnetic field 806 may decrease, while the direction of the applied magnetic field 806 remains parallel to the static quantization field 802, until the experienced quantization field 810 is approximately equal to the static quantization field 802.

As the experienced quantization field 810 rotates continuously during performance of the continuous passive dynamical decoupling sequence, the magnetic field dependence of the energy and/or frequency of the hyperfine sublevels (which are defined with respect to the static quantization field 802) changes continuously during performance of the continuous passive dynamical decoupling sequence. Moreover, the changes in the magnetic field dependence of the energy and/or frequency of the hyperfine sublevels varies in a symmetric manner as the experienced quantization field 810 rotates around a circle (e.g., the dependence may vary as a cosine function of the angle of rotation with respect to the direction of the static quantization field 802 and/or the like). Thus, magnetic field noise accumulated by the quantum object while in the continuous passive dynamical decoupling sequence is performed on the quantum object is approximately zero (assuming there are not large spikes in the amplitude of any stray magnetic fields in the vicinity of the quantum processor during performance of the continuous passive dynamical decoupling sequence).

At step 730, the controller 30 may store quantization field rotation information in a classical qubit/qudit registry (e.g., stored in the memory 210). For example, in various embodiments, the memory 210 of the controller 30 may store a classical qubit/qudit registry. The classical qubit/qudit registry includes information regarding each qubit/qudit of the quantum processor. For example, the classical qubit/qudit registry may include an entry for each qubit/qudit of the quantum processor. A respective qubit/qudit entry of the classical qubit/qudit register is indexed by a qubit/qudit identifier configured to uniquely identify the qubit/qudit in the quantum circuit, a current location of the qubit/qudit, a phase accumulation tracker for the qubit/qudit, a heat accumulation tracker for the qubit/qudit, one or more software-based quantum error corrections for the qubit/qudit, and/or the like.

In various embodiments, a qubit/qudit registry corresponding to the quantum object disposed at the defined location 420 is updated to include quantization field rotation information corresponding to the performance of the continuous passive dynamical decoupling sequence on the quantum object. For example, quantization field rotation information may include a time at which the continuous passive dynamical decoupling sequence was performed, the number of rotations N the experienced quantization field 810 was rotated, the length of time that the experienced quantization field 810 was rotated, any trackable change in phase caused by the performance of the continuous passive dynamical decoupling sequence on the quantum object, any noise accumulation caused by performance of the continuous passive dynamical decoupling sequence on the quantum object, and/or other information corresponding to effects experienced by the quantum object as a result of the performance of the continuous passive dynamical decoupling sequence on the quantum object. For example, the controller 30 comprises means, such as processing element 205, memory 210, and/or the like for updating the classical qubit/qudit registry with quantization field rotation information corresponding to the performance of the continuous passive dynamical decoupling sequence performed on the quantum object disposed at the defined location 420.

In various embodiments, a continuous passive dynamical decoupling sequence is performed on a single quantum object disposed at the defined location 420 at a time. In various embodiments, continuous passive dynamical decoupling sequences are performed in parallel, simultaneously, and/or at least partially overlapping in time on a plurality of quantum objects each disposed at a respective one of a plurality of defined locations of the confinement apparatus. In various embodiments, a continuous passive dynamical decoupling sequence is performed on two or more quantum objects disposed at the defined location 420 at the same time and/or simultaneously. For example, a continuous passive dynamical decoupling sequence may be performed on two or more quantum objects (e.g., a pair of quantum objects) disposed at the defined location 420 at the same time and/or simultaneously to cause performance of an entangling gate on the two or more quantum objects.

### Example Entangling Gate Using Passive Dynamical Decoupling

In various embodiments, passive dynamical decoupling may be used to apply a spin-dependent force to a pair of quantum objects. Experiencing of the spin-dependent force by the pair of quantum objects causes the pair of quantum objects to experience a two-qubit and/or entangling gate. For example, experiencing the spin-dependent force may cause the pair of qubit objects to undergo and/or experience a ZZ-gate.

In various embodiments, the pair of quantum objects are caused to experience the spin-dependent force as a result of being in the presence of a static (e.g., generally and/or substantially not evolving with time) magnetic field gradient while the applied magnetic field is caused to rotate at a rotation frequency that corresponds to a selected motional mode of the quantum objects. For example, the applied magnetic field is caused to rotate with a rotation frequency ωᵣ and the selected motional mode of the quantum objects is associated with a mode frequency ωₐ. A detuning δ is defined as the difference between the mode frequency and the rotation frequency (δ≡ωₐ-ωᵣ). In various embodiments, the detuning δ is no more than 10% of the mode frequency ωₐ. In some embodiments, the detuning δ is no more than 5% of the mode frequency ωₐ. In certain embodiments, the detuning δ is no more than 1% of the mode frequency ωₐ. In various embodiments, the motional mode and/or the rotation frequency is/are selected such that ωₐ±ωᵣ is far-detuned from the Zeeman splitting of the quantum objects.

In an example embodiment, continuous passive dynamical decoupling is used to perform the gate. For example, the applied magnetic field may be rotated an integer multiple of 360 degrees to cause performance of the two-qubit gate and/or entangling gate. For example, the gate time, the amount of time for which the gate is performed, may be a positive integer n multiplied by the reciprocal of the rotation frequency ωᵣ (e.g., n·ωᵣ⁻¹).

Key technical advantages of the passive dynamical decoupling two-qubit and/or entangling gate include that the use of continuous passive dynamical decoupling during the performance of the gate continuously dynamically decouples the gate from magnetic field noise, suppressing qubit dephasing during the gate. Additionally, there is not requirement to directly drive a transition between qubit states of the qubit objects. Notably, the rotation frequency may correspond to and/or be tuned near a motional mode of the quantum objects in a static magnetic field gradient. For example, the magnetic field gradient need not be an oscillating field, such as a field having oscillations with a frequency in the 1-20 GHz range (e.g., corresponding to a frequency difference between the qubit states so as to directly drive transition between the qubit states). For example, a quantum computer 110 may include components configured to generate a constant and/or permanent magnetic field gradient (e.g., permanent magnets) at the defined location 420.

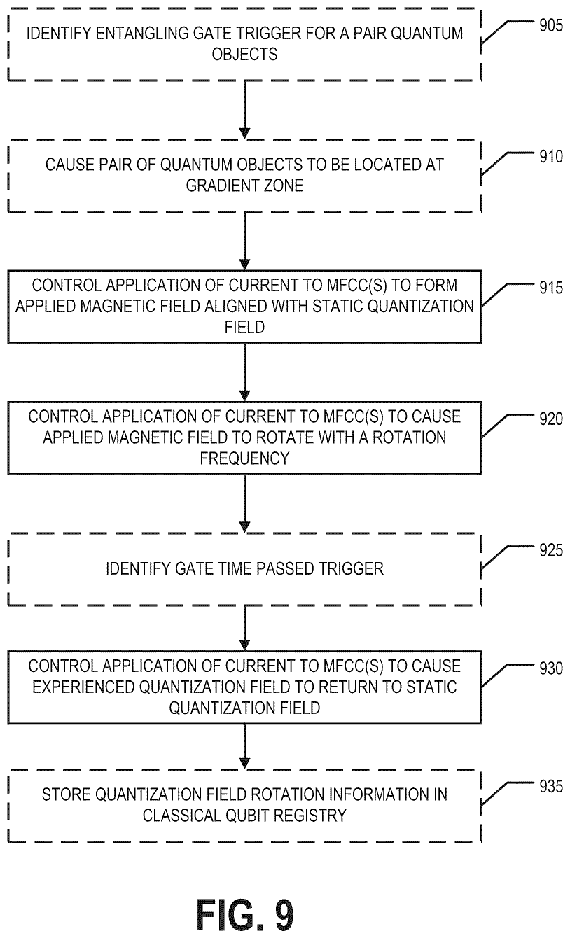

FIG. 9 provides a flowchart illustrating various processes, procedures, and/or the like of performing a two-qubit gate and/or entangling gate on a pair of quantum objects using passive dynamical decoupling. Starting at step 905, a controller 30 identifies an entangling gate trigger corresponding to and/or identifying a pair of quantum objects. For example, the controller 30 comprises means, such as processing element 205, memory 210, communication interface 220, A/D converter 225, and/or the like, for identifying an entangling gate trigger for a pair of quantum objects. For example, the controller 30 may store a queue of executable instructions configured to cause, when executed by the controller 30, the quantum computer 110 to perform a quantum circuit and/or program. Based on the queue of executable instructions, the controller 30 may determines that a pair of quantum objects are to be gated together using an entangling gate and, based thereon, identify an entangling gate trigger corresponding to the pair of quantum objects. Various embodiments may identify an entangling gate trigger corresponding to and/or identifying a pair of quantum in a variety of manners as appropriate for the application.

At step 910, the controller 30 controls operation of the current and/or voltage sources 50 to cause the pair of quantum objects identified by the entangling gate trigger to be located at the defined location 420. For example, the defined location 420 may be a location at which the MFCC 400 is configured to generate an applied magnetic field and/or one or more magnetic field generators 80A, 80B are configured to generate a static magnetic field gradient (e.g., a magnetic field gradient that substantially does not evolve with time over the gate time). When a quantum object of the pair of quantum objects is located at the defined location 420, the controller 30 may control operation of the current and/or voltage sources 50 to cause the quantum object to remain and/or be maintained at the defined location 420. When a quantum object of the pair of quantum objects is not located at the defined location 420, the controller 30 may control operation of the current and/or voltage sources 50 to cause the quantum object to be transported through the confinement apparatus 70 from a current location of the quantum object to the defined location 420.

In certain embodiments, the controller 30 may determine that the quantum object has been shelved and/or transitioned to a magnetic field sensitive sublevel or that the quantum object is to be shelved and/or transitioned to a magnetic field sensitive sublevel (e.g., from an information carrying clock state, for example). For example, the controller 30 may control operation of one or more manipulation sources 60 and/or beam path systems 66 to cause one or more shelving manipulation signals to be incident on the pair of quantum objects. The one or more shelving manipulation signals are configured to shelve and/or map the quantum state of each quantum object of the pair of quantum objects to a respective magnetic field sensitive sublevel (e.g., from a respective information carrying clock state, for example). For example, the controller 30 may be configured to perform an entangling gate using a continuous passive dynamical decoupling sequence on a pair of quantum objects with each quantum object of the pair of quantum objects in a magnetic field sensitive sublevel to reduce an effect of magnetic field noise on the entangling gate.

At step 915, the controller 30 controls operation of the current and/or voltage sources 50 to cause application of one or more currents to the MFCC 400 (e.g., to respective ones of the circuit elements 405) to cause an applied magnetic field to be formed. For example, the controller 30 comprises means, such as processing element 205, memory 210, driver controller elements 215, and/or the like, for controlling operation of the current and/or voltage sources 50 to cause application of one or more currents to the MFCC 400 (e.g., to respective ones of the circuit elements 405) to cause an applied magnetic field to be formed. The applied magnetic field is aligned with the static quantization field. One or more currents are applied to the MFCC 400 associated with and/or corresponding to the defined location 420 to cause an applied magnetic field at the defined location 420 that is aligned with the static quantization field. In an example embodiment, the controls operation of the current and/or voltage 50 to cause application of one or more currents to the MFCC 400 (e.g., to respective ones of the circuit elements 405) to cause the applied magnetic field to be formed responsive to determining that the quantum objects of the pair of quantum objects have been shelved to respective magnetic field sensitive states.

For example, similar to as shown in FIG. 8, at an initial time t₀ the pair of quantum objects disposed at the defined location 420 experiences an experienced quantization field 810. The experienced quantization field 810 is substantially equal to the static quantization field 802. For example, the experienced quantization field 810 is in the same direction as the static quantization field 802 and has the same magnitude as the static quantization field 802. For example, at the initial time t₀ the amplitude of the applied magnetic field 806 is zero and/or negligible compared to the static quantization field 802.

At a first time t₁, an applied magnetic field 806 is generated by the MFCC 400 (e.g., by application of appropriate currents to the circuit elements 405A, 405B, 405C) that is in the same direction as the static quantization field 802. For example, the static quantization field 802 defines a static quantization axis 804 and the applied magnetic field 806 is parallel to the static quantization axis 804. The quantum object disposed at the defined location 420 experiences an experienced quantization field 810 that is the combination of the static quantization field 802 and the applied magnetic field 806. At the first time t₁, the experienced quantization field 810 is in the same direction as the static quantization field 802 and greater in amplitude than the static quantization field 802.

In various embodiments, the respective currents are applied to the circuit elements 405 such that the amplitude of the applied magnetic field 806 goes from being approximately zero and/or negligent compared to the static quantization field 802, to a first amplitude at time t₁ slowly. For example, amplitude of the applied magnetic field 806 increases slowly compared to the inverse of the frequency difference between adjacent hyperfine sublevels of the quantum object (e.g., 1/Δf). For example, the time required for the applied magnetic field 806 to increase from being approximately zero and/or negligent compared to the static quantization field 802, to a first amplitude at time t₁ occurs over a period of time that is longer than the inverse of the frequency difference between adjacent hyperfine sublevels of the quantum object (e.g., 1/Δf), in various embodiments. For example, the applied magnetic field 806 may be turned on (e.g., increase in amplitude from approximately zero and/or negligent compared to the static quantization field 802 to the first amplitude) adiabatically.

In some embodiments, the static magnetic field gradient at the defined location 420 is generated by a permanent magnet or a set of permanent magnets. In such embodiments, the controller 30 need not control a magnetic field generator 80A, 80B to cause generation of the static magnetic field gradient. In some embodiments, the static magnetic field gradient at the defined location 420 is generated by an electromagnet, Helmholtz coil, and/or the like. In such embodiments, the controller 30 controls operation of one or more magnetic field generators 80A, 80B (in some instances by controlling operation of one or more current and/or voltage sources 50 configured to provide current and/or voltage signals to the one or more magnetic field generators 80A, 80B) to cause the generation of the static magnetic field gradient at the defined location 420. In embodiments where the static magnetic field gradient is not permanent and is “turned on” in order to perform the entangling gate, the static magnetic field gradient may be increased from an approximately zero and/or negligent amplitude to a gate amplitude slowly and/or adiabatically. For example, the amplitude of the static magnetic field gradient may be increased from approximately zero and/or a negligent amplitude to the gate amplitude over a period of time that is slow compared to the inverse of the frequency difference between adjacent hyperfine sublevels of the quantum object (e.g., 1/Δf). For example, the time required for the static magnetic field gradient to increase from being approximately zero and/or having a negligent amplitude to a gate amplitude occurs over a period of time that is longer than the inverse of the frequency difference between adjacent hyperfine sublevels of the quantum object (e.g., 1/Δf), in various embodiments. In various embodiments, when necessary, the controller 30 controls operation of the magnetic field generator(s) 80A, 80B such that the magnetic field gradient at the defined location 420 is substantially static (e.g., not evolving with time) during the rotation of the applied magnetic field.

Continuing with FIG. 9, at step 920, the controller 30 controls application of current to the MFCC 400 (e.g., circuit elements 405) to cause the applied magnetic field 806 to rotate with a rotation frequency ωᵣ. In various embodiments, the rotation frequency ωᵣ corresponds to a mode frequency ωₐ of a selected motional mode of the quantum objects. In various embodiments, the magnitude of the applied magnetic field 806 remains larger than the magnitude of the static quantization field 802 while the applied magnetic field 806 is rotated. For example, rotating the applied magnetic field 806 causes the experienced quantization field 810 to rotate with the rotation frequency ωᵣ. For example, the controller comprises means, such as processing element 205, memory 210, driver controller elements 215, and/or the like, for controlling application of current to the MFCC 400 to cause the applied magnetic field 806 rotate with the rotation frequency ωᵣ.

For example, as shown in FIG. 8, the applied magnetic field 806 rotates between the first time t₁ through a sixth time t₆ (e.g., a times t₁-t₆). The applied magnetic field 806 continues to rotate after the sixth time t₆ such that the experienced quantization field 810 rotates an integer number of times around a complete circle. For example, the applied magnetic field 806 continuously rotates such that the experienced quantization field 810 rotates a total of n*360 degrees, where n is a positive integer.

As the applied magnetic field 806 rotates with the rotation frequency ωᵣ, the pair of quantum objects experiences a spin-dependent force based at least in part on the static magnetic field gradient. The experiencing of the spin-dependent force by the pair of quantum objects results in a \hat{σ}_{z}⊗\hat{σ}_{z} operation being performed on the pair of quantum objects. In other words, the pair of quantum objects experiences a ZZ gate.

Returning to FIG. 9, at step 925, the controller 30 may identify a gate time passed trigger for the entangling gate being performed on the pair of quantum object. For example, the controller 30 may comprise means, such as processing element 205, memory 210, and/or the like for identifying a gate time passed trigger for the entangling gate being performed on the pair of quantum objects. For example, in various embodiments, the controller 30 is configured to cause the experienced quantization field 810 to rotate a total of n*360 degrees, where n is a positive integer, or n complete rotations. The number n may be preset such that the controller 30 identifying the gate time passed trigger when the applied magnetic field 806 begins the nth rotation.

In another example, the controller 30 may be configured to cause the experienced quantization field 810 to rotate for a set time period (e.g., the gate time). The controller 30 may determine when the set time period has elapsed since the rotation of the applied magnetic field 806 began and, based thereon, identify a gate time passed trigger. In various embodiments, the controller 30 may be configured to determine when to halt or stop the continuous rotation of the applied magnetic field 806 (and therefore of the experienced quantization field 810) in various manners, as appropriate for the application.

For example, the number of rotations n and or the set time period may be set such that the entangling gate is performed for an appropriate time to cause the entangling interaction of the gate to be performed (a.k. a. a gate time). In an example embodiment, the gate time is approximately 1/Ω_{zz}, where Ω_{zz}=μ_{B} g_{J} B′_{z} βₐ is the transition rate associated with the \hat{σ}_{z}⊗\hat{σ}_{z} operation of the entangling gate and where μB is the magnetic permeability, g_{J} is the Landég-factor, B′_{z} is the derivative of the experienced quantization field 810 with respect to the quantization direction z, and βₐ is the projection of the \hat{z}-operator onto the selected motional mode.

At step 930, the controller 30 controls application of current to the MFCC 400 (e.g., the circuit elements 405) to cause the experienced quantization field 810 to return to the static quantization field 802 (e.g., such that the experienced quantization field 810 is approximately equal to the static quantization field 802). For example, the controller 30 controls application of current to the MFCC 400 to cause the applied magnetic field 806 to stop rotating while the applied magnetic field 806 (and therefore the experienced quantization field 810) is aligned with and/or parallel to the static quantization field 802.

In various embodiments, the rotation of the applied magnetic field 806, and therefore the experienced quantization field 810, is ended adiabatically. For example, the angular speed of the rotation of the applied magnetic field 806 smoothly and continuously reaches zero when the applied magnetic field 806 is aligned with the static quantization field 802.

After the rotation of the applied magnetic field 806 has stopped (e.g., after rotation of n*360 degrees, n complete rotations, and/or such that the applied magnetic field 806 is parallel to and/or aligned with the static quantization field 802), the currents provided to the circuit elements 405 of the MFCC 400 causes the magnitude of the applied magnetic field 806 to decrease while maintaining the direction of the applied magnetic field 806 as being parallel to the static quantization field 802. In various embodiments, the amplitude of the applied magnetic field 806 is reduced until the applied magnetic field 806 has zero amplitude and/or an amplitude that is negligible compared to the static quantization field 802 amplitude. For example, the amplitude of the applied magnetic field 806 may decrease, while the direction of the applied magnetic field 806 remains parallel to the static quantization field 802, until the experienced quantization field 810 is approximately equal to the static quantization field 802.

As the experienced quantization field 810 rotates continuously during performance of the continuous passive dynamical decoupling sequence, the magnetic field dependence of the energy and/or frequency of the hyperfine sublevels (which are defined with respect to the static quantization field 802) changes continuously during performance of the continuous passive dynamical decoupling sequence (e.g., the rotation of the experienced quantization field 810). Moreover, the changes in the magnetic field dependence of the energy and/or frequency of the hyperfine sublevels varies in a symmetric manner as the experienced quantization field 810 rotates around a circle (e.g., the dependence may vary as a cosine function of the angle of rotation with respect to the direction of the static quantization field 802 and/or the like). Thus, magnetic field noise accumulated by the quantum object while the entangling gate is performed on the pair of quantum objects is approximately zero (assuming there are not large spikes in the amplitude of any stray magnetic fields in the vicinity of the quantum processor during performance of the entangling gate using passive dynamical decoupling).

In various embodiments, the controller 30 de-shelves the quantum objects of the pair of quantum objects from magnetic field sensitive states to information carrying clock states and/or other states that are less sensitive to magnetic fields than the magnetic field sensitive states. For example, in certain embodiments, after performance of the entangling gate, the respective quantum states of each quantum object of the pair of quantum objects is mapped back to a respective information carrying clock state and/or other state that is less sensitive to magnetic fields than the magnetic field sensitive states. For example, the controller 30 may control operation of one or more manipulation sources 60 and/or beam path systems 66 to cause one or more de-shelving manipulation signals to be incident on the pair of quantum objects. The one or more de-shelving manipulation signals are configured to de-shelve and/or map the quantum state of each quantum object of the pair of quantum objects to from a respective magnetic field sensitive sublevel (e.g., to a respective information carrying clock state, for example).

At step 935, the controller 30 may store quantization field rotation information and/or gate performance information in a classical qubit/qudit registry (e.g., stored in the memory 210). For example, in various embodiments, the memory 210 of the controller 30 may store a classical qubit/qudit registry. The classical qubit/qudit registry includes information regarding each qubit/qudit of the quantum processor. For example, the classical qubit/qudit registry may include an entry for each qubit/qudit of the quantum processor. A respective qubit/qudit entry of the classical qubit/qudit register is indexed by a qubit/qudit identifier configured to uniquely identify the qubit/qudit in the quantum circuit, a current location of the qubit/qudit, a phase accumulation tracker for the qubit/qudit, a heat accumulation tracker for the qubit/qudit, one or more software-based quantum error corrections for the qubit/qudit, and/or the like.

In various embodiments, respective qubit/qudit registries corresponding to the quantum objects of the pair of quantum objects are updated to include quantization field rotation information and/or gate performance information corresponding to the performance of the continuous passive dynamical decoupling sequence on the quantum object and/or performance of the entangling gate on the pair of quantum objects. For example, quantization field rotation information may include a time at which the continuous passive dynamical decoupling sequence was performed, the number of rotations n the experienced quantization field 810 was rotated, the length of time that the experienced quantization field 810 was rotated, any trackable change in phase caused by the performance of the continuous passive dynamical decoupling sequence on the quantum object, any noise accumulation caused by performance of the continuous passive dynamical decoupling sequence on the quantum object, and/or other information corresponding to effects experienced by the quantum object as a result of the performance of the continuous passive dynamical decoupling sequence of the entangling gate on the quantum object. For example, the controller 30 comprises means, such as processing element 205, memory 210, and/or the like for updating the classical qubit/qudit registry with quantization field rotation information and/or entangling gate performance information corresponding to the performance of the entangling gate and/or the continuous passive dynamical decoupling sequence on the pair of quantum objects disposed at the defined location 420.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for passively dynamically decoupling magnetic field sensitive sublevels of a quantum object confined by a confinement apparatus at a defined location, the confinement apparatus (a) configured to confine one or more quantum objects and (b) comprising at least one magnetic field control circuit (MFCC) associated with the defined location, the defined location defined by the confinement apparatus, wherein the method comprises:
controlling current provided to the at least one MFCC to cause the at least one MFCC to generate an applied magnetic field at the defined location that is in a direction that is aligned with a static quantization direction of a static quantization field associated with the confinement apparatus and that has an amplitude that is larger than an amplitude of the static quantization field, wherein the static quantization direction defines a static quantization axis; and
controlling the current provided to the at least one MFCC to cause the applied magnetic field generated by the at least one MFCC to rotate such that an experienced quantization field experienced by the quantum object disposed at the defined location rotates,
wherein an angular velocity of rotation of the experienced quantization field is less than two pi times a frequency difference between adjacent hyperfine sublevels of the quantum object.

2. The method of claim 1, further comprising, when the experienced quantization field is rotated substantially 180 degrees from the static quantization direction, controlling the current provided to the at least one MFCC to cause the amplitude of the applied magnetic field to decrease to less than the amplitude of the static quantization field while the experienced quantization field remains parallel to the static quantization axis.

3. The method of claim 1, further comprising, when the experienced quantization field is rotated an integer multiple of 360 degrees, controlling the current provided to the at least one MFCC to cause the amplitude of the applied magnetic field to decrease to less than the amplitude of the static quantization field while the static quantization field remains aligned with the static quantization direction.

4. The method of claim 3, wherein the rotation of the experienced quantization field is performed while the quantum object is in a magnetic field sensitive sublevel.

5. The method of claim 1, wherein the method is performed by a controller configured to control one or more current and/or voltage sources configured to provide current and/or voltage signals to one or more electrical components of the confinement apparatus.

6. The method of claim 5, wherein the controller is configured to control the current provided to the at least one MFCC by controlling operation of a respective current and/or voltage source of the one or more current and/or voltage sources.

7. The method of claim 5, wherein the controller comprises a non-transitory memory device and the method further comprises storing quantization field rotation information corresponding to the rotation of the experienced quantization field in the non-transitory memory device in association with a quantum object identifier configured to identify the quantum object disposed at the defined location during the rotation of the experienced quantization field.

8. The method of claim 1, wherein the quantum object is a qubit of a quantum computer comprising the confinement apparatus, and the rotation of the experienced quantization field is performed during performance of a quantum circuit by the quantum computer.

9. The method of claim 1, wherein the rotation of the experienced quantization field causes a modification in a hyperfine sublevel energy linear dependence on magnetic field such that magnetic field-based noise experienced by the quantum object is reduced by performance of the rotation of the experienced quantization field.

10. A system configured for performing passive dynamical decoupling of magnetic field sensitive sublevels of a quantum object, the system comprising:
a confinement apparatus configured to confine the quantum object, wherein the confinement apparatus (a) defines, at least in part, a defined location and (b) comprises at least one magnetic field control circuit (MFCC) associated with the defined location;
one or more current and/or voltage sources configured to provide electrical current and/or voltage signals to one or more electrical components of the confinement apparatus; and
a controller configured to control operation of the one or more current and/or voltage sources, the controller comprising at least one processing element and a non-transitory memory storing executable instructions, the memory and the executable instructions configured to, when executed by the at least one processing element configured to cause the controller to perform at least:
controlling a current provided to the at least one MFCC to cause the at least one MFCC to generate an applied magnetic field at the defined location that is in a direction that is aligned with a static quantization direction of a static quantization field associated with the confinement apparatus and that has an amplitude that is larger than an amplitude of the static quantization field, wherein the static quantization direction defines a static quantization axis; and
controlling the current provided to the at least one MFCC to cause the applied magnetic field generated by the at least one MFCC to rotate such that an experienced quantization field experienced by the quantum object disposed at the defined location rotates,
wherein an angular velocity of rotation of the experienced quantization field is less than two pi times a frequency difference between adjacent hyperfine sublevels of the quantum object.

11. The system of claim 10, wherein the memory and the executable instructions are further configured to, when executed by the at least one processing element configured to cause the controller to perform at least, when the experienced quantization field is rotated substantially 180 degrees from the static quantization direction, controlling the current provided to the at least one MFCC to cause the amplitude of the applied magnetic field to decrease to less than the amplitude of the static quantization field while the experienced quantization field remains parallel to the static quantization axis.

12. The system of claim 10, wherein the memory and the executable instructions are further configured to, when executed by the at least one processing element configured to cause the controller to perform at least, when the experienced quantization field is rotated an integer multiple of 360 degrees, controlling the current provided to the at least one MFCC to cause the amplitude of the applied magnetic field to decrease to less than the amplitude of the static quantization field while the static quantization field remains aligned with the static quantization direction.

13. The system of claim 12, wherein the rotation of the experienced quantization field is performed while the quantum object is in a magnetic field sensitive sublevel.

14. The system of claim 10, wherein the controller is configured to the current provided to the at least one MFCC by controlling operation of the one or more current and/or voltage sources.

15. The system of claim 10, wherein the memory and the executable instructions are further configured to, when executed by the at least one processing element configured to cause the controller to perform at least storing quantization field rotation information corresponding to the rotation of the experienced quantization field in the non-transitory memory in association with a quantum object identifier configured to identify the quantum object disposed at the defined location during the rotation of the experienced quantization field.

16. The system of claim 10, wherein the quantum object is a qubit of a quantum computer comprising the confinement apparatus and the controller, and the rotation of the experienced quantization field is performed during performance of a quantum circuit by the quantum computer.

17. The system of claim 10, wherein the confinement apparatus is a surface ion trap formed on a chip and the at least one MFCC is an integrated circuit formed on or in the chip.

18. The system of claim 17, wherein the at least one MFCC comprises a first circuit element that is parallel to a confinement axis of the confinement apparatus at the defined location and a second circuit element and a third circuit element that are parallel to one another and transverse to the first circuit element.

19. The system of claim 18, wherein at least one of:
the controller is configured to independently control respective currents applied to the first circuit element, the second circuit element, and the third circuit element, or
the first circuit element, the second circuit element, and the third circuit element each include at least one respective substantially linear portion.

20. A method for performing an entangling gate on a pair of quantum objects confined by a confinement apparatus at a defined location, the confinement apparatus (a) configured to confine a plurality of quantum objects, the plurality of quantum objects comprising the pair of quantum objects and (b) comprising at least one magnetic field control circuit (MFCC) and at least one magnetic field generator associated with the defined location, the defined location defined by the confinement apparatus, wherein the method comprises:
causing the pair of quantum objects to be located at the defined location such that the pair of quantum objects experiences a static magnetic field gradient generated by the at least one magnetic field generator associated with the defined location;
controlling current provided to the at least one MFCC to cause the at least one MFCC to generate an applied magnetic field at the defined location that is in a direction that is aligned with a static quantization direction of a static quantization field associated with the confinement apparatus and that has an amplitude that is larger than an amplitude of the static quantization field, wherein the static quantization direction defines a static quantization axis; and
controlling the current provided to the at least one MFCC to cause the applied magnetic field generated by the at least one MFCC to rotate such that an experienced quantization field experienced by the pair of quantum objects disposed at the defined location rotates with a rotation frequency, wherein the rotation frequency corresponds to a motional mode of a quantum object of the plurality of quantum objects.
